(19) United States
(12) Patent Application Publication
(10) Pub. No.: US 2022/0147940 A1
(43) Pub. Date: May 12, 2022

(54) SYSTEMS AND METHODS FOR A COLLABORATIVE PLATFORM FOR THE DEVELOPMENT OF ELECTRONIC VISIT AGENDA DOCUMENTS

(71) Applicant: CDK Global, LLC, Hoffman Estates, IL (US)

(72) Inventors: Charlotte Aveline Louise Mattier, Austin, TX (US); Taylor Michael Coppock, Austin, TX (US); Herschel Sanjay Kulkarni, Allen, TX (US); Ryan James Stevens, Pflugerville, TX (US); Jason Marks, Austin, TX (US); Margarita S. Tijerino, Volente, TX (US); David Bryan Portillo, Austin, TX (US); Sarah Torres, Austin, TX (US)

(21) Appl. No.: 17/525,420

(22) Filed: Nov. 12, 2021

Related U.S. Application Data
(60) Provisional application No. 63/113,005, filed on Nov. 12, 2020.
(60) Provisional application No. 63/113,001, filed on Nov. 12, 2020.

(51) Int. Cl. G06Q 10/10; G06Q 10/06; G06F 16/93

(52) U.S. Cl. CPC G06Q 10/103; G06Q 10/101; G06F 16/93; G06Q 10/0637; G06Q 10/06393; G06Q 10/063118

(57) ABSTRACT

Collaborative platforms that allow for the creation, updating, maintenance of capture of effective dynamic workflow documents are disclosed. Embodiments of such collaborative platforms may allow effective workflow documents to be generated for an organization in the context of management of geographically distributed outlets.

### RELATED APPLICATION(S)

This application claims a benefit of priority under 35 U.S.C. 119 to U.S. Provisional Application No. 63/113,005, filed Nov. 12, 2020, entitled “Collaborative Platform for Development of Visit Agenda Documents,” by Mattier et al., and U.S. Provisional Application No. 63/113,001, filed Nov. 12, 2020, entitled “Identifying and Presenting Metrics for Integration into Visit Agenda Documents,” by Zeng et al., which are hereby incorporated herein for all purposes.

### TECHNICAL FIELD

This disclosure relates generally to collaborative computing platforms. More specifically, this disclosure relates to collaborative platforms for the development of workflow documents for facilitating communications and management of outlets of an organization, including the recommendation and inclusion of data and content into workflow documents of individuals within the organization responsible for the management of such geographically distributed outlets. Even more particularly, this disclosure relates to collaborative platforms that provide for the recommendation, prioritization, identification or selection of such data and content for inclusion into such workflow documents to facilitate the creation of useful and effective workflow documents that may integrate high-priority metric and which may be particularly germane in the context of hierarchical management of outlets of a geographically distributed organization. Additionally, this disclosure relates generally to analytics for such collaborative platform that allow for the prioritization and identification of selected metrics for recommendation to a user to facilitate the integration of such high-priority metrics into those workflow documents.

### BACKGROUND

In the modern world, the amount and types of data obtained or produced is almost continuously increasing. Contrary to commonly held wisdom, the availability of such a plethora of data may not always prove a boon. In particular, the availability of such a wide swath of data raises the problem of determining what data to focus on in a given context. In fact, in some cases, individuals may not even be aware certain data exists. These types of situation occur often in real-world contexts. For example, an individual or organization may desire to use data for evaluation of various facets of their organization, often in collaboration with other individuals. The question then becomes what data is available for such an evaluation, and what of that data should be evaluated given time or other constraints imposed on the evaluation of those facets or associated data in order to perform such an evaluation more efficiently. Thus, the problem becomes not is data available to center such an evaluation on, but instead what data of an ever increasing and overwhelming amount of data that is available should be utilized in a given context to most effectively perform or guide such an evaluation.

These problems are exacerbated in the context of larger organizations, enterprises or other entities (all used herein interchangeably) in which parts of the organization are distributed or otherwise not heterogenous and where many people may be interacting with such parts and make use of workflow documents. To illustrate more specifically, in such contexts there may be a huge amount of data regarding the organization and its parts. Problems then arise regarding what data should be selected and included in such workflow documents, and in particular how to select such data when, in fact, a user creating a workflow document for a part of an organization may not even be aware that such data even exists or what data is most germane to that user's part of the organization or the user's role within the organization. Moreover, because users in such organizations may be responsible for multiple parts an organization, and data regarding the organization is constantly changing, it may be difficult to track such data for particular parts of the organization over time or to interact or otherwise gain visibility into how such data should be utilized when interacting with those parts subsequently or how that data is being utilized by other users or members of the organization.

What is desired are collaborative platforms that provide for the generation, maintenance and updating of workflow document, where such collaborative platforms can provide for the identification, recommendation, and prioritization of data metrics to a user while constructing workflow documents to facilitate the integration of such high-priority metrics into those workflow documents.

### SUMMARY

As will be recalled from the above discussion, the unchecked growth of data in modern organizations can prove both beneficial and problematic. Beneficial in that a wide variety of data (including metrics, such as performance metrics or the like) are available for use in addressing certain aspects of an organization. Problematic in that the data that is truly important to focus on in certain contexts may not be readily apparent, and tracking such dynamic data over time (e.g., with respect to the particular context in which it is useful) may prove even more difficult still, especially given the structure of many organizations, enterprises, or other entities (all used herein interchangeably).

Specifically, such organizations are commonly geographically distributed. An organization may, for example have widely (geographically) distributed retail outlets with more centralized management. For instance, an automotive corporation (e.g., an automotive Original Equipment Manufacturer (OEM)) may have many dealerships throughout the country, but may have only several regional management locations and a headquarters from which the entire organization is managed. In this situation, the organization may depend on “field teams” (which may, in some cases be a single manager, such as a “district” or “regional” manager) in the headquarters or regional locations to periodically visit with the dealerships in various geographically distributed regions so that they can coach the dealerships on performance, document their discussions with the dealerships, and so on, thereby managing the dealerships' performance.

The interactions of the field teams with the dealerships on these field visits are important in the management of the dealerships, but it may be difficult ensure that the interactions are effective because each field team commonly relies on its own, individual experience and skills, and the use of conventional tools (e.g., paper notebooks, printed reports, business software for word processing and email) to prepare for discussions with dealerships (e.g., develop agendas), and to document the discussions. For example, a regional manager would collect information about a particular dealership and would generate talking points (using a word processing application, a spreadsheet application, a slide presentation application, etc.) for discussion with the dealership, such as how the dealership might improve sales.

The regional manager would then make a field visit (e.g., a physical or virtual visit) to the dealership, present the talking points to the dealership, make observations or suggestions, etc. Some of the problems with this process are that the process relies on the regional manager to find the information for the talking points, manually check the relevant data, individually determine what should be discussed, then visit the dealership and manually organize and communicate all that information, typically in pen-and-paper format. Once the field visit has been conducted, the regional manager may follow up outside the visit by manually generating contact reports (what was discussed, what the dealership will do in response to the visit, etc.) to document the field visit.

This ad hoc approach to field visits is not organized or efficient, and has a number of drawbacks, such as inconsistency between different field teams, inconsistency in the discussions of a given field team with different dealerships, inconsistency in the documentation of field visits, inefficient transitions when there is staff turnover, and a lack of corporate visibility into both the execution and the outcome of field visits. For example, with respect to the determination of which metrics are included in the materials for a visit, field teams may need to include one or more metrics to effectively communicate issues to the outlets, but the volume and frequency with which metrics data is generated is so great that the field teams cannot keep pace, and cannot make well-informed decisions regarding the best metrics to include in the materials for the visits. Thus, these field teams face a great challenge in collecting information in a common place and remembering to discuss such information with the outlets, not to mention trying to recall what data was discussed, or tracking such data over time, when a subsequent interaction with the outlet occurs.

What is desired, then, are collaborative platforms that provide for the generation, maintenance, updating, and capture of dynamic workflow document, where such collaborative platforms can provide for the identification, recommendation, and prioritization of data metrics to a user while constructing workflow documents to facilitate the integration of such high-priority metrics into those workflow documents.

To those ends, among other, attention is directed to embodiments of collaborative platforms that allow for the creation, updating, maintenance of capture of effective dynamic workflow documents. Such embodiments may allow effective workflow documents to be generated for an organization in the context of management of geographically distributed outlets. In particular, embodiments may be particularly useful in the automotive context for developing workflow document for outlets of an automotive OEM, including visit agendas or the like. Thus, for ease of understanding in this disclosure, embodiments and examples will be described in such a context, and workflow documents will be referred to interchangeably as visit agendas. It will be understood, however, that while embodiments as disclosed herein may be usefully utilized in the context of automotive organizations, and the generation and maintenance of workflow documents for visit agendas for the outlets (e.g., dealerships) of such organizations, other embodiments of collaborative platforms as disclosed may be effectively utilized in other contexts, and the description of such embodiments in the context of automotive organizations is provided solely for ease of understanding and without loss of generality.

Embodiments of a collaborative platform may thus allow for the development of a visit agendas for automotive outlets of an automotive OEM that include a number of items. These visit agenda may, for example, be specific to the user and a particular automotive outlet associated with the user. And the items included in such visit agendas may include user generated or selected data or content (used herein interchangeably) or data generated or identified for inclusion in the item by the collaborative platform, or both. Such a visit agenda comprising the included items and associated data (e.g., metrics) may be stored at the collaborative platform in association with the visit agenda. Moreover, any dynamic data included in the items of the agenda may be tracked and dynamically updated by the collaborative platform over time as those metrics change at the collaborative platform, such that when the visit agenda is subsequently accessed (e.g., by the creating user or another user) the data in the item of the visit agenda includes the current value for that dynamic data. In that way, pertinent data (e.g., metrics) can be tracked over time (e.g., without specific user intervention) along with notes related to those metrics. Accordingly, visit agendas generated and maintained by the collaborative platform are not a one-time static document, but instead are a dynamically evolving document that can be utilized repeatedly (e.g., on subsequent interactions with the outlet).

Moreover, the collaborative platform may allow the creation of “contact reports” from these dynamic visit agendas. The user may access a visit agenda (e.g., during or after a visit to an outlet has been performed) and may add commentary or notes and create a contact report. When this contact report is created it may get stored as a separate document at the collaborative platform with an associated timestamp. Such a contact report may be “sealed” such that the contact report cannot be changed to document the occurrence of the visit to the outlet and the data discussed or presented during such a visit. In this manner, the contact report can serve as documentary evidence while maintaining the visit agenda itself as a dynamic document.

In some embodiments, then, a collaborative platform may maintain data about the organization and associated users affiliated with that organization. Specifically, the collaborative platform may store organization data that included region data associated with geographic divisions of the organization. The organization data may also include outlet data on outlets of that organization. Each of the outlets (e.g., the outlet data for the outlet) may be associated with one or more of the regions of the organization. Thus, the organization data, includes data on outlets (e.g., dealers) of the organization (e.g., automotive OEM) and each of set of geographic regions for those outlets (e.g., which outlets are in which geographic region).

Data selected for inclusion into a visit agenda may thus be based on data or a configuration provided by a user associated with a high (e.g., top) level of the organization such as the automotive OEM, may be based on the outlet for which the visit agenda is being created, or may be based on attributes associated with a perspective of a user accessing a dynamic workflow document at the collaborative platform. The collaborative platform may thus allow the perspective driven creation, update or other access, to visit agendas by users such that the user may be presented with, and include, data germane to that organization, that user's perspective and the particular outlet for which the user is creating the agenda.

To illustrate in more detail, using embodiments of the collaborative platform, the user may elect to create a visit agenda for a particular outlet. The collaborative platform may present a visit agenda comprising a set of visit agenda items through the visit agenda interface and the user may add to, or select (when permitted by the collaborative platform) which items to include in the visit agenda and which data or metrics to include in each visit agenda item. This visit agenda can then be saved at the collaborative platform for subsequent use by the user. The set of users who have created visit agendas for the same outlet may also be presented to the user through the visit agenda interface to allow the user to view the visit agenda created by these other users for the same outlet.

Embodiments of the collaborative platform may also create and present a focus metric visit agenda item comprising a set of focus metrics based on the specification data associated with the organization. These focus metrics may be certain data that the organization may desire a user to discuss with an outlet and may thus be metrics that the collaborative platform automatically includes in a visit agenda. The collaborative platform may also create and present required visit agenda item comprising a set of required items for the agenda based on the specification data associated with the organization. These required items may be data that the organization wants the user to discuss with an outlet (e.g., based on performance related issues or the like). The organization may desire that such items be included in the visit agenda such that there can be a record that such items were discussed with the outlet and that the organization can prove or document that such items were discussed (e.g., when a contact report gets created from such a visit agenda, as discussed). The collaborative platform may also create and present a recommended metrics agenda item comprising a set of recommended metrics for the agenda for that user and outlet.

Accordingly, embodiments as discussed herein may provide a number of advantages. For example, when creating and utilizing workflow documents users may only be presented with items in agenda documents that are relevant to their perspective, whether that be their geography or their role within an organization or some other facet of their perspective. Moreover, embodiments may allow these agenda documents to be dynamic documents that evolve by including relevant data (e.g., metrics) that is substantially continuously updated at the rate that the data itself changes, such data integrated into the agenda document (and the agenda document itself) is always current. Additionally, high priority or otherwise important metrics relevant to a particular user and outlet may be efficiently identified and included in such agendas such that users do not miss important data, including data that is desired by the organization itself or may be of the greatest interest, or mast impactful, to the user or the outlet. As some other advantages, embodiments of such collaborative platforms may also allow users to easily share their agendas and to learn and leverage from each other's visit agenda and may allow easy creation of snapshots of those agendas as contact reports.

In one embodiment, a collaborative platform for the development of a visit agenda document comprises a processor and a data store, storing data on a set of users, each user associated with a perspective definition, wherein the perspective definition comprises a role attribute and a geographic indicator associated with one of a set of geographic regions. The data can also include data on a set of outlets, each outlet associated with at least one of the set of geographic regions and a set of visit agendas, each visit agenda associated with a corresponding outlet and user of the set of users and comprising a set of visit agenda items. The data can also include data on a set of metrics, each metric associated with one of the set of outlets or one or more of the set of geographic regions, where each of the set of metrics is updated at an interval.

In various embodiments the collaborative platform may be adapted to present a first visit agenda interface for a first user, the first visit agenda interface adapted to allow the first user to access a first visit agenda for a first outlet associated with the first user at a first time, where the first outlet is one of the set of outlets determined based on the perspective definition of the first user. A set of visit agenda items can be determined for the first visit agenda for the first outlet associated with the first user, where a first visit agenda item of the set of visit agenda items for the first visit agenda comprises a set of metrics selected for the first visit agenda item based on the first outlet and the perspective definition associated with the first user. A user selection of one or more metrics of the set of metrics can be received at the collaborative platform in association with a user interaction of the first user with the first visit agenda item of the first visit agenda. The first visit agenda comprising the set of visit agenda items can be stored, including the first visit agenda item comprising the one or more metrics of the set of metrics. Additionally, the first visit agenda can be dynamically updated, including dynamically updating the first agenda item in the first visit agenda by updating the one or more metrics of the set of metrics of the first agenda item as the one or more metrics is updated in the data store.

In some embodiments, a second user may be determined, where the second user is associated with the outlet and has a second visit agenda associated with the second user stored in the data store. This second user can be presented to the first user in the visit agenda interface, such that the first user can access the second visit agenda associated with the second user.

In a particular embodiment, the first visit agenda can be stored as a first contact report associated with a second time, wherein the first contact report comprises a value of the first visit agenda item, including the one or more metrics, at the first time.

In a specific embodiment, dynamically updating the first visit agenda may include determining that the first user is accessing the first visit agenda at a third time, determining that the one or more metrics has been updated since the first visit agenda was stored, and dynamically updating the first visit agenda before presenting the first visit agenda to the first user at the third time based on the determination that the one or more metrics has been updated.

In another embodiment, the first visit agenda can be stored as a second contact report associated with a fourth time, wherein the first contact report comprises a value of the first visit agenda item, including the one or more metrics, at the second time.

In one embodiment, the set of visit agenda items comprise one or more of a recommended metrics visit agenda item, a focus metrics agenda item, or a required visit agenda item.

In some embodiments, first visit agenda comprises a recommended metric visit agenda item, comprising a set of recommended metrics associated with the first user and the first outlet. The set of s recommend metrics can be determined by determining metrics of the set of metrics associated with the perspective definition of the first user and the first outlet, ranking the determined metrics associated with the perspective definition of the first user and first outlet, and selecting a set of top ranked metrics as the set of recommended metrics. The first visit agenda can be presented to the first user, including presenting the set of recommended metrics in the recommended metric visit agenda item of the first visit agenda.

In an embodiment, the set of recommended metrics is based on an indication of importance of at least one metric of the set of metrics associated with the perspective definition of the first user and the first outlet provided by a second user.

In other embodiments, the ranking of the determined metrics associated with the perspective definition of the first user and first outlet is based on a threshold associated with at least one of the determined metrics, a trend of at least one of the determine metrics or a relative ranking of at least one of the determine metrics relative to other outlets of the set of outlets. Additionally, in some embodiments the ranking of the determined metrics is based on a Z score across the set of determined metrics.

In a specific embodiments, the collaborative platform may receive an indication of a dismissal of a first recommended metric of the set of recommended metrics based on a user interaction with the recommended metrics visit agenda item, determine a next recommended metric from the ranked determined recommended metrics; and present the next recommended metric in the recommended metric visit agenda item of the first visit agenda in place of the first recommended metric.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagram illustrating the interaction of various users with a collaborative platform for creating a visit agenda document in accordance with some embodiments.

FIGS. 2A-2B are diagrams illustrating the structure of a collaborative platform in accordance with some embodiments.

FIG. 3 is a flow diagram illustrating a method for creating and using a visit agenda document using a collaborative platform in accordance with some embodiments.

FIGS. 4A-4B are diagrams illustrating an exemplary view of an interface to a collaborative platform for the creation of a visit agenda document in accordance with some embodiments.

FIGS. 5-9 are block diagrams depicting embodiments of an interface of a collaborative platform for the creation of visit agenda documents.

FIG. 10 is a flow diagram illustrating a recommended metrics engine in accordance with some embodiments.

FIG. 11 is a flow diagram illustrating an exemplary method for examining metrics data and selecting one or more metrics to recommend to a user in accordance with some embodiments.

FIG. 12 is a chart that illustrates an example of recommended metrics prioritization in accordance with some embodiments.

FIG. 13 is a chart illustrating an adjustment factor that increases as t increases in accordance with some embodiments.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before delving into specific embodiments, some context may be useful. As discussed, modern organizations such as automotive OEMs and their dealer are geographically distributed. These types of organization may thus depend on “field teams” (which may, in some cases be a single manager, such as a “district” or “regional” manager) in the headquarters or regional locations to periodically visit with the dealerships in various geographically distributed regions so that they can coach the dealerships on performance, document their discussions with the dealerships, and so on, thereby managing the dealerships' performance.

The interactions of the field teams with the dealerships on these field visits are important in the management of the dealerships, but it may be difficult ensure that the interactions are effective because that the process relies on the manager to find the information for the talking points, manually check the relevant data, individually determine what should be discussed, then visit the dealership and manually organize and communicate all that information, typically in pen-and-paper format. Once the field visit has been conducted, the manager may follow up outside the visit by manually generating contact reports (what was discussed, what the dealership will do in response to the visit, etc.) to document the field visit.

This ad hoc approach to field visits is problematic in no small part because of a lack of visibility into the data that may be utilized with for such visits. For example, with respect to the determination of which metrics are included in the materials for a visit, field teams may need to include one or more metrics to effectively communicate issues to the outlets, but the volume and frequency with which metrics data is generated is so great that the field teams cannot keep pace, and cannot make well-informed decisions regarding the best metrics to include in the materials for the visits. Thus, these field teams face a great challenge in collecting information in a common place and remembering to discuss such information with the outlets, not to mention trying to recall what data was discussed, or tracking such data over time, when a subsequent interaction with the outlet occurs.

What is desired, then, are collaborative platforms that provide for the generation, maintenance, updating, and capture of dynamic workflow document, where such collaborative platforms can provide for the identification, recommendation, and prioritization of data metrics to a user while constructing workflow documents to facilitate the integration of such high-priority metrics into those workflow documents.

To those ends, among other, attention is directed to embodiments of collaborative platforms that allow for the creation, updating, maintenance of capture of effective dynamic workflow documents. Such embodiments may allow effective workflow documents to be generated for an organization in the context of management of geographically distributed outlets. In particular, embodiments may be particularly useful in the automotive context for developing workflow document for outlets of an automotive OEM, including visit agendas or the like. Thus, for ease of understanding in this disclosure, embodiments and examples will be described in such a context, and workflow documents will be referred to interchangeably as visit agendas. It will be understood, however, that while embodiments as disclosed herein may be usefully utilized in the context of automotive organizations, and the generation and maintenance of workflow documents for visit agendas for the outlets (e.g., dealerships) of such organizations, other embodiments of collaborative platforms as disclosed may be effectively utilized in other contexts, and the description of such embodiments in the context of automotive organizations is provided solely for ease of understanding and without loss of generality.

Embodiments of a collaborative platform may thus allow for the development of a visit agendas for automotive outlets of an automotive OEM that include a number of items. These visit agenda may, for example, be specific to the user and a particular automotive outlet associated with the user. And the items included in such visit agendas may include user generated or selected data or content (used herein interchangeably) or data generated or identified for inclusion in the item by the collaborative platform, or both. Such a visit agenda comprising the included items and associated data (e.g., metrics) may be stored at the collaborative platform in association with the visit agenda. Moreover, any dynamic data included in the items of the agenda may be tracked and dynamically updated by the collaborative platform over time as those metrics change at the collaborative platform, such that when the visit agenda is subsequently accessed (e.g., by the creating user or another user) the data in the item of the visit agenda includes the current value for that dynamic data. In that way, pertinent data (e.g., metrics) can be tracked over time (e.g., without specific user intervention) along with notes related to those metrics. Accordingly, visit agendas generated and maintained by the collaborative platform are not a one-time static document, but instead are a dynamically evolving document that can be utilized repeatedly (e.g., on subsequent interactions with the outlet).

Moreover, the collaborative platform may allow the creation of “contact reports” from these dynamic visit agendas. The user may access a visit agenda (e.g., during or after a visit to an outlet has been performed) and may add commentary or notes and create a contact report. When this contact report is created it may get stored as a separate document at the collaborative platform with an associated timestamp. Such a contact report may be “sealed” such that the contact report cannot be changed to document the occurrence of the visit to the outlet and the data discussed or presented during such a visit. In this manner, the contact report can serve as documentary evidence while maintaining the visit agenda itself as a dynamic document.

Embodiments thus provide a collaborative platform in which a field team (e.g., a regional manager) can develop a visit agenda (e.g., which can be used as a set of presentation materials) as one or more digital objects that can be accessed not only by the field team developing the visit, but also the outlet of the organization that is the subject of the visit, as well as higher-level managers of the organization. The outlet may, for example, have restricted access to the visit, so that it may submit comments or respond to items in the visit, but may not be able to add or edit items. This may allow the outlet to actually start acting on the items or reacting to them immediately as opposed to waiting for the physical visit from the field team. The upper-level managers may also have restricted access, such as the ability to comment or add items, but with limited ability to edit existing items.

The collaborative platform integrates various tools and processes needed by the field team into a single platform that facilitates the creation and integration of the items in the visit. These tools and processes make the visit more consultative and effective by, for example incorporating data, action planning, and human-generated content into the field team's workflow. With the collaborative platform, the field team have desired tools in one place, so they can pull information directly from their notes, data, reports and other resources to incorporate the information into the visit agenda. The use of the collaborative platform allows the workflow associated with the visit to be more structured, so that the field team can develop, present and follow up the visit in a more organized and efficient way than was previously possible.

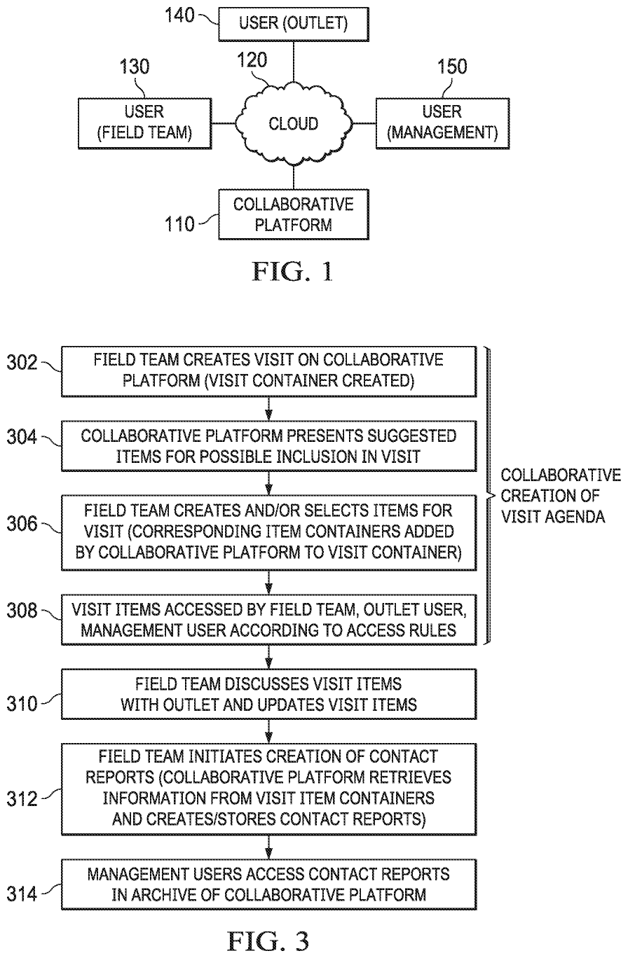

Referring then to FIG. 1, a diagram illustrating the interaction of various users with a collaborative platform for creating a visit in accordance with some embodiments is shown. In this embodiment, a collaborative platform 110 is communicatively coupled to various users through a network 120. Collaborative platform 110 can be accessed by a field team user 130 (e.g., such as a regional or district manager of automotive dealers). As noted above, the field team is tasked with generating an agenda for discussion with an outlet of an organization in order to provide management (e.g., coaching) of the outlet. Field team user 130 can therefore interact with collaborative platform 110 to generate a visit agenda for the visit. Outlet user 140 is also able to access collaborative platform 110 for purposes such as responding to items on the visit agenda, providing feedback on various items, or the like. Outlet user 140 may have limited access to the visit items. For example, while field team user 130 may create the visit agenda and add items to the agenda, outlet user 140 may be limited to reading the agenda items or providing written responses to agenda items, and may not be able to independently create items for the visit agenda.

Management user 150 (a user in the management or higher level of an organization such as an automotive OEM) can also access collaborative platform 110 to provide data related to the organization such as items or data the organization wants collaborative platform to periodize or require. The management user may also assist in the development of the visit agenda or to access contact reports resulting from the visit. Management user 150 may have full access to a visit agenda (i.e., the management user may have the same access rights as field team user 130) or contact reports created therefrom, or the rights of the management user may be restricted (e.g., this user may have read access, and may suggest agenda items, but may not create items).

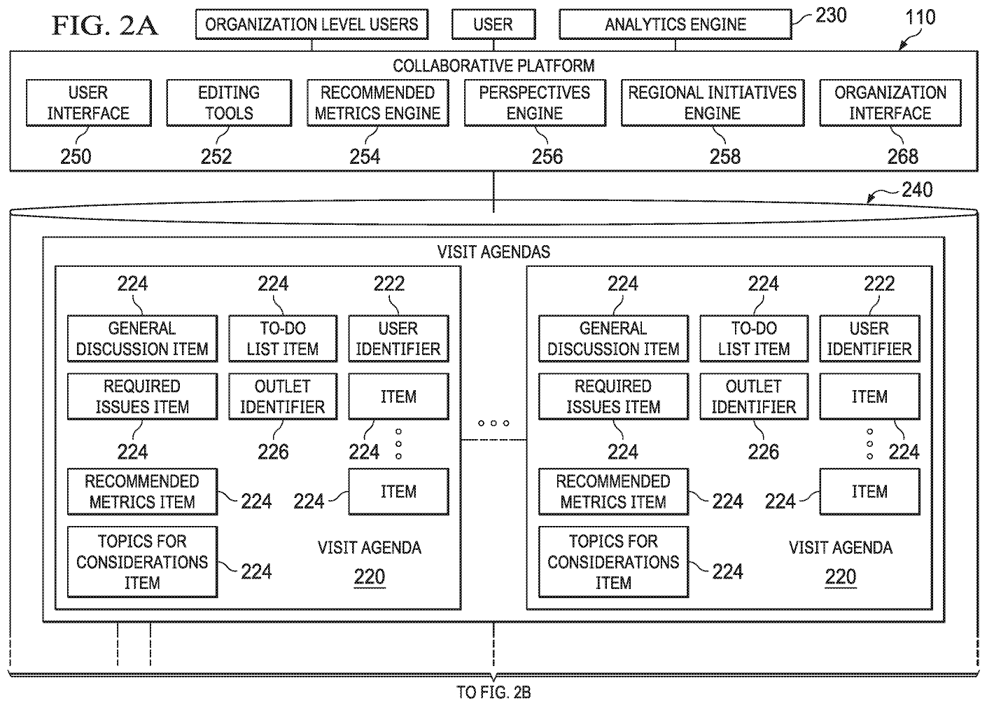

Referring to FIGS. 2A-2B, a diagram illustrating the structure of a collaborative platform in accordance with some embodiments is shown. As depicted in this figure, collaborative platform 110 is accessed by a user 210 to create a visit agenda document 220. As noted above, user 210 may be a field team user who creates the visit agenda document for use in reviewing or coaching persons at an outlet of the organization, an outlet user who can respond to or augment items added to the visit agenda document by the field team user, or a management user who can suggest or review agenda items. Collaborative platform 110 includes a user interface 250 which allows user 210 to access the platform and to access (e.g., create, edit, update, use or otherwise access) visit agenda document 220. Various editing tools 252 are provided by the collaborative platform to enable the user to access and manipulate the visit agenda document. These tools may include, without limitation, word processors, spreadsheets, graphical tools, or any other suitable tool which may be used in the creation, manipulation or use of the agenda document.

Collaborative platform 110 is coupled to an analytics engine 230 and a data repository 240 which may be used to store and provide information for the visit agendas, to store visit agendas 220 or to store organization data 230. Data repository 240 may consist of one or more data stores, and may include various types of data such as emails, performance data, text documents, images, or any other type of information which may be maintained by the organization. Analytics engine 230 may be configured to retrieve or analyze data in data source 242 and may provide this information to collaborative platform 110. Analytics engine 230 may be configured, for example, to generate metrics 242 based on the data retrieved from data source 240 and to provide these metrics 242 to the collaborative platform 110 so that they can be presented in, and incorporated by, user 210 into agenda document 220. The collaborative platform 110 may written, for example, in a hybrid ReactJS/AngularJS JavaScript framework with a Ruby/Rails backend. It uses a combination of MySQL database for application level data value storage, as well as API access to the data infrastructure for detailed analytics, metrics metadata, and prioritized metrics for the user.

Some embodiments of collaborative platform 110 include a recommended metrics engine 254 which is configured to identify one or more of the metrics 282 generated by analytics engine 230 and to present the recommended metrics to user 210 for possible inclusion in a visit agenda 220. This may be particularly useful because there may be a wide variety of metrics 282 that could be potentially included by the user in the agenda document, and it may be difficult for the user to be aware of all of the available metrics. Recommended metrics engine 254 may identify particular ones of the metrics that are relevant to the outlet associated with the visit agenda 220, and may present these to the field team user, who can then select one or more of the identified metrics 282 for inclusion in the agenda document.

Some embodiments of the collaborative platform include a perspectives engine 256 which is configured to facilitate generation of the visit agenda document by tailoring the items in the visit agenda 220 to cover only, or to include, visit items which are relevant to the particular representatives (e.g., field team representatives and outlet representatives) who are associated with the agenda document or the outlet for which the visit agenda 220 is being created. Thus, the collaborative platform is adapted to simplify the visit agenda document 220 so that it does not include visit items that are not relevant to the field team representative or the outlet. The perspectives engine 256 may, however, identify for a specific field team member ones of the excluded visit items which are being (or will be) included for discussion in an agenda document for a different representative. In this manner, the representative associated with the current agenda document can be made aware that any items of concern will be covered by other representatives.

Some embodiments of the collaborative platform include a regional initiatives engine 258 which is configured to identify visit items based upon input from management users. Thus, a management user can designate particular items which the management user deems to be priorities for one or more outlets within their region, and the regional initiatives engine can automatically include the designated items in any agenda document that is generated for one of these outlets. Alternatively, the designated items can be automatically presented to the field team user creating the agenda document, and the field team user can select one or more of these designated items for inclusion in the agenda document. This allows the designated priority items to be consistently included in visit agenda documents associated with outlets in the respective regions.

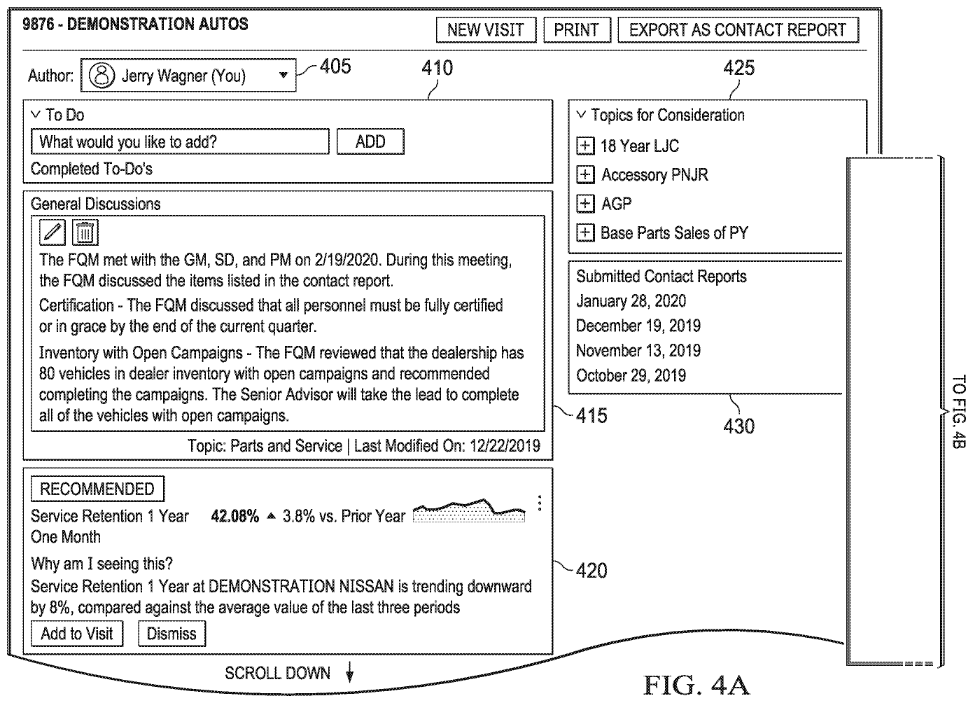

Referring briefly to FIGS. 4A-4B, a diagram illustrating an example of one embodiments of an interface to a an embodiment of a collaborative platform which is presented to a field team user for the creation of a visit agenda document is shown. The interface depicted in this figure includes, for example, an area 405 that can be used to identify the field team user who is associated with the electronic visit agenda document. In some embodiments, the interface may also include a component which allows identification of the outlet of the organization with which the agenda document is associated. In this embodiment, a “to do” list 410 is presented to enable the identification of specifically enumerated items for discussion during the visit between the field team and the outlet. A notes section 415 is provided to allow the field team user to enter a textual description of the topics to be discussed, or any notes for the discussion. A metrics section 420 is provided to enable the field team user to include metrics that are based on data provided by the analytics engine. These metrics may include, for example, a description of the metric, a numerical metric, a graphical representation of the metric, and an indicator of the reason for inclusion of the metric in the agenda document.

The interface may include a list of proposed topics for discussion 425 that are identified by the collaborative platform and are presented to the field team user for possible inclusion in the visit agenda document. These topics or associated data may be automatically included in the agenda document upon selection by the field team user, or they may simply be indicators/reminders to the field team user that it may be desirable to include these topics. Although not shown in this figure, the interface may likewise include a list of recommended metrics that the field team user may wish to incorporate into the agenda document. As depicted in the figure, the interface also includes a list of previously submitted contact reports 430 that were generated and stored with respect to the outlet associated with the current agenda document. One or more of the items displayed in the interface may be linked to corresponding information (e.g., the contact report identifiers may be linked to full copies of the corresponding reports, the identified topics for consideration may be linked to corresponding documents or data, identified recommended metrics may be linked to corresponding data and graphical representations, and so on). The interface also includes, in the depicted embodiment, data (e.g., an email) which was previously captured and stored in the data sources coupled to the collaborative platform and was therefore available to be retrieved by the field team user and included in the agenda document.

It may now be useful to discuss embodiments of the collaborative platform in more detail. As discussed, embodiments of collaborative platform 110 may thus allow for the development of a visit agendas 220 for automotive outlets of an automotive OEM that include a number of items. These visit agenda 220 may, for example, be specific to the user and a particular outlet associated with the user, and include an identifier 226 of the corresponding outlet 206 and an identifier 222 of the corresponding user 284 that created the visit agenda 220. The items 224 included in such visit agendas may include user generated or selected data or content (used herein interchangeably) or data generated or identified for inclusion in the item by the collaborative platform, or both. Such a visit agenda 220 comprising the included items and associated data (e.g., metrics) may be stored at the collaborative platform in association with the visit agenda. Moreover, any dynamic data included in the items of the agenda may be tracked and dynamically updated by the collaborative platform over time as those metrics change at the collaborative platform, such that when the visit agenda is subsequently accessed (e.g., by the creating user or another user) the data in the item of the visit agenda includes the current value for that dynamic data. In that way, pertinent data (e.g., metrics) can be tracked over time (e.g., without specific user intervention) along with notes related to those metrics. Accordingly, visit agendas generated and maintained by the collaborative platform are not a one-time static document, but instead are a dynamically evolving document that can be utilized repeatedly (e.g., on subsequent interactions with the outlet).

Moreover, the collaborative platform 110 may allow the creation of “contact reports” 270 from these dynamic visit agendas 220. The user may access a visit agenda 220 (e.g., during or after a visit to an outlet has been performed) and may add commentary or notes and create a contact report 270. When this contact report 270 is created it may get stored as a separate document at the collaborative platform 110 with an associated timestamp 272 and an identifier 274 of the associated visit agenda 220 from which it was created. The contact report 270 may include the state (e.g., values) of all the items 276 of the corresponding visit agenda 220 (identified by visit identifier 274) at the time the contact report 270 was created (e.g., as identified by timestamp 272). Such a contact report 270 may be “sealed” such that the contact report 270 cannot be changed to document the occurrence of the visit to the outlet and the data discussed or presented during such a visit using the corresponding visit agenda 220 identified by the visit identifier 274. In this manner, the contact reports 270 can serve as documentary evidence while maintaining the visit agenda 220 itself as a dynamic document. For example, there may be a set 278 of contact reports 270, where each of the contact reports 270 of the set corresponds to the same dynamic visit agenda 220. Each of this set 278 of contact reports 270 were created at a different point in time, and thus includes values of the same corresponding visit agenda 220 at that point in time while the items of the visit agenda 220 may have continued to dynamically change across that timespan.

Accordingly, in a typical collaborative platform 110 workflow, when a user initially creates a visit agenda 220 for a particular outlet of an organization, a user will have a visit agenda 220 for the outlet that may include items generated by the collaborative platform 110 as a starting point based on the outlet, the user's perspective, or other criteria. The user may then accept, alter, add to, remove, etc. data from the items of the visit agenda 220, based on what they see as relevant to the discussions they desire to have during the physical visit to the outlet or other criteria. Throughout the process of planning or preparing for a visit, the user may interact with the visit agenda 220 through the collaborative platform 110 to continue to add, remove, edit, etc. the data of the agenda items as they refine the visit agenda 220, as well as sharing and collaborating with other users as necessary leading up to the physical visit. After a physical visit has occurred, the visit agenda 220 may be further updated based on the discussions which the user had, and eventually the visit agenda 220 will be sent to a compliance or archiving component of the collaborative platform 110 to create a contact report 270 from the visit agenda 220. When it is desired to subsequently visit the outlet, or for other reasons, the user may again access the same visit agenda 220 for that outlet. The data of the items of the agenda that have changed (e.g., varied dynamically) during the intervening time between the last time the visit agenda 220 was accessed will be updated in the visit agenda 220 such that the user has those new values in the visit agenda 220 and can then accept, alter, add to, remove, etc. data from the items of the visit agenda 220 based on those new data values.

In some embodiments, then, collaborative platform 110 may maintain data about the organization and associated users affiliated with that organization. Specifically, the collaborative platform 110 may store organization data 202 that includes region data 204 associated with geographic divisions of the organization. The organization data 202 may also include outlet data 206 on outlets of that organization. Each of the outlets (e.g., the outlet data 206 for the outlet) of the organization may be associated with one or more of the regions 204 of the organization. Thus, the organization data 202, includes data on outlets 206 (e.g., dealers) of the organization (e.g., automotive OEM) and each of set of geographic regions for those outlets (e.g., which outlets are in which geographic region). It will be noted that an organization may have a specific, or proprietary definitions, of regions 204 and that the region 204 and outlet data 206 associated with the organization at the collaborative platform 110 may be specific to that particular organization. Thus, regional identifiers for regional data 204 may be geographic regions such as states or zip codes, regions defined by the organization, designated market areas (DMAs), or the like.

The collaborative platform 110 may also include organization data 202 that includes metric data 280 associated with the regions 204 or outlets 206 of the organization. This data 280 may include metrics 282 (e.g., performance or other types of metrics) associated with these one or more regions 204 or outlets 206 of the organization. These metrics 282 may get updated on a regular basis (e.g., which may be different time periods or the same periods for each metric 282), such as by an analytics engines 230. The organization data 202 may include data on users associated with that organization such as a user profile 284 for each user of the collaborative platform 110 associated with the organization. The user profile 284 may include a perspective definition 286 comprising a set of perspective attributes associated with that user, including for example a geographic indicator 288 indicating a geography (e.g., region) associated with that user 284 along with other attributes such as a position, group, division or role within the organization (e.g., a user's title), associated users, demographic information, or other data associated with a user that is desired to be utilized to determine or present data to a user when that user is accessing a visit agenda 220.

The organization data 202 may also include organization specified data that may include data that the organization wishes to utilize in determining or presenting data to user for inclusion in a visit agenda 220 when the user is accessing such a visit agenda 220. In certain embodiments, the collaborative platform 110 may thus present an organization interface 268 for a user associated with a top of higher level in the organization (a manager or other type of user the organization), such as a user associated with an automotive OEM (e.g., a manufacturer of vehicles being sold through that OEM's dealers). A user associated with the organization may utilize that interface 268 to define certain parameters for presenting data or content to a user associated with that organization when accessing a visit agenda 220. The parameters may include a data specification 290 including “focus metric” parameter defining data (e.g., metrics 282) that an organization desires a user to discuss with an outlet on a visit. These focus metrics parameters may be associated with one or more values for perspective attributes 286 or criteria associated with a region 204 or outlet 206 such that those metrics 282 are included in a visit agenda 220 only if those perspective attributes or criteria match a user 284 or outlet 206.

This data specification 290 may also include “required issues” parameters that define the data that (e.g., particular types of) users 284 must discuss with an outlet. Thus, these required issues parameters may include one or more values for attributes of a user 284 (e.g., such as perspective attributes 286 of a user such a geographical indicator or position within the organization), or a region 204, or even a particular outlet 206, and one or more associated metrics 282 that will be presented or included in a visit agenda 220 if a user 284 or outlet associated with an accessed visit agenda 220 meets the criteria specified by those parameters.

The organization data 202 may also include required items rules 292 which specify one or more metrics 282 and an associated threshold or range such that when a user access a visit agenda 220 for a particular outlet 206 (e.g., in a particular region 204) and the metric 282 meets the rule (e.g., falls above or below the threshold, inside or outside of the range, etc.) the metric 282 may be presented to the user or included in the visit agenda 220 (e.g., if the metric 282 is also associated with the user perspective as defined by the perspective attributes 286).

Data selected for inclusion into the visit agenda 220 may thus be based on data 202 or a configuration provided by a user associated with a high (e.g., top or managerial) level of the organization such as the automotive OEM; may be based on the outlet 206 for which the visit agenda 220 is being created or the region 204 of the outlet; or may be based on attributes associated with a perspective 286 of a user accessing a visit agenda 220 at the collaborative platform 110. The collaborative platform 110 may thus allow the perspective driven creation, update or other access, to visit agendas 220 by users such that the user may be presented with, and include, data germane to that organization, that user's perspective and the particular outlet for which the user is creating the agenda 220. For example, if a user that occupies a particular role in the organization (e.g., if a user is a district manager (DM) on one side of an organization (e.g., sales of cars)) they are going to have a certain perspective (e.g., set of data set presented or recommended while accessing a visit agenda 220 for an outlet), while if the user is in another position on another side of the organization (e.g., a service manager) they are going to see a different perspective when accessing a visit agenda (even for the same outlet).

These visit agendas 220 may be stored in the data store 240 when created, and accessed by users of the collaborative platform 110. These visit agendas 220 may include a visit data container that may be associated with a region 204 or other geographic location (e.g., a geographic location or an outlet associated with a geographic location), as well as an identification 222 of the actual owner user who the visit agenda 220 is associated with and an identification 226 of the outlet 226 corresponding to the visit agenda 220. This visit agenda 220 can be ‘shared’ with other users to varying degrees in order to allow collaboration with different individuals throughout the collaborative platform's workflow to create and use the visit agenda 220. Within this visit data container, there exist a series of visit agenda items 224, which may be sub-containers of the parent visit agenda 220 and may encapsulate data or logic, as well as some user input information (such as comments or notes). The content of a visit item 224 can be added to a visit in several ways. For example, users can select to add a visit item 224 via a context menu of available item containers, or an item container can be promoted at the application level to all, or a subset of, users.

In particular, when a user access a visit agenda 220, the user interface 250 may present a set of visit agenda items 224 that the user may interact with to add, update, modify or otherwise access these visit agenda items 224. Examples of such visit agenda items may include:
A discussion visit item—provides an item 224 which can have a defined title, text body, as well as a flag that may cause the user interface 250 to require the user to acknowledge and add notes to it. The required flag may only be set for some application created discussion items.
Metric visit agenda item 224—provides an item which displays a set of visualizations and values around a specific set of metric data 228. Such an item may also have a text body attached to it, as well as a flag that may cause the user interface 250 to require the user to acknowledge and add notes to it. The required flag may only be set for some application created discussion items.
Topics for Consideration visit agenda item 224—provides a list of ‘topics’ which, when one is clicked, may add a pre-generated discussion or metric to the visit agenda 220.
Recommended Metric visit agenda item 224—provides a metric item, which may have the ability (e.g., through a button or other interaction in the interface) to add it to the agenda 220 or dismiss it. The metric information displayed within this item may be determined by a recommend metrics engine of the collaborative platform 110.
File Data visit agenda item 224—provides an item which holds a data file (image file, pdf document, etc.), which can either be uploaded by the user or created by the collaborative platform and allows for the user to edit the text body attached to it.
To-Do List agenda item 224—provides a list of items of attention for the visit agenda 220 and may be used for tracking actions within the visit agenda 220. Actions can be added to the list, removed, or marked as completed by the user.

For these visit agenda items 224, further control of the available content is provided through the use of a perspectives engine 256. For example, the metrics 282 to which a user has access (e.g., to add to a visit agenda 220) may be controlled by the perspectives engine 286. This engine 286 allows sets of data (e.g., content) to be associated with specific users, or groups of users, though, for example, a perspective data container. Users can be associated with multiple perspectives, and the available content from each perspective is additive in nature, coalescing into a user's available content set. Additionally, certain content can be pushed down to groups of users, and highlighted as points of discussion, through the use of the regional initiatives engine 258. This engine 258 may provide users with the ability to configure content per regional hierarchy level, and have that content displayed within any visit agenda 220 associated with that hierarchy level.

To illustrate in more detail, when a user is accessing a visit agenda 220 the collaborative platform 110 may present data that a user may include in the visit agenda 220 (e.g., as a visit agenda item 224), where that data may comprise a set of perspective driven data based on the user's perspective definition. This perspective driven data may include data metrics 282 associated with a geographic region 204 or a particular outlet 206 (e.g., associated with the user or the visit agenda being created), where the set of metrics may, for example, be presented in a ranked order based on the perspective of the user. Once such a data metric 282 is added to the visit agenda 220, the user may add comments or other annotations that may be linked with the metric 282 in the agenda 220 (e.g., in the recommended metrics agenda item 224). Additionally, once the metric 282 is added to the visit agenda 220 it will be updated in association with that visit agenda (e.g., in the recommended metrics agenda item 224) when that metric 282 is updated at the collaborative platform 110.

In some embodiments, then, when a user access the collaborative platform 110 the collaborative platform 110 may access the user profile 284 of the user, including the user's perspective definition 286 and the geographic region identifier 288 associated with the user. Based on the perspective definition 286 and the geographic region identifier, the collaborative platform 110 may determine a set of outlets associated with the user (e.g., the user's region 204). The user can then be given the ability in the interface 250 to create, or otherwise access, a visit agenda 220 for one of the set of outlets associated with the user, where that visit agenda 220 may ultimately be utilized by that user in association with a visit (e.g., physical or virtual) with the outlet (e.g., or a representative of that outlet).

Using this visit agenda interface 250, the user may elect to create a visit agenda 220 for a particular outlet. The collaborative platform 110 may present a visit agenda 220 comprising a set of visit agenda items 224 through the visit agenda interface 250 and the user may add to, or select (when permitted by the collaborative platform 110) which items 224 to include in the visit agenda 220 and which data (e.g., metrics 282) to include in each visit agenda item 224. This visit agenda 220 can then be saved at the collaborative platform 110 for subsequent use by the user. Accordingly, when the user accesses the interface 250 for creating the visit agenda 220 for an outlet, the collaborative platform 110 may access the organization data 202 to determine one or more users associated with that organization that have (e.g., previously) created a visit agenda 220 for that same outlet.

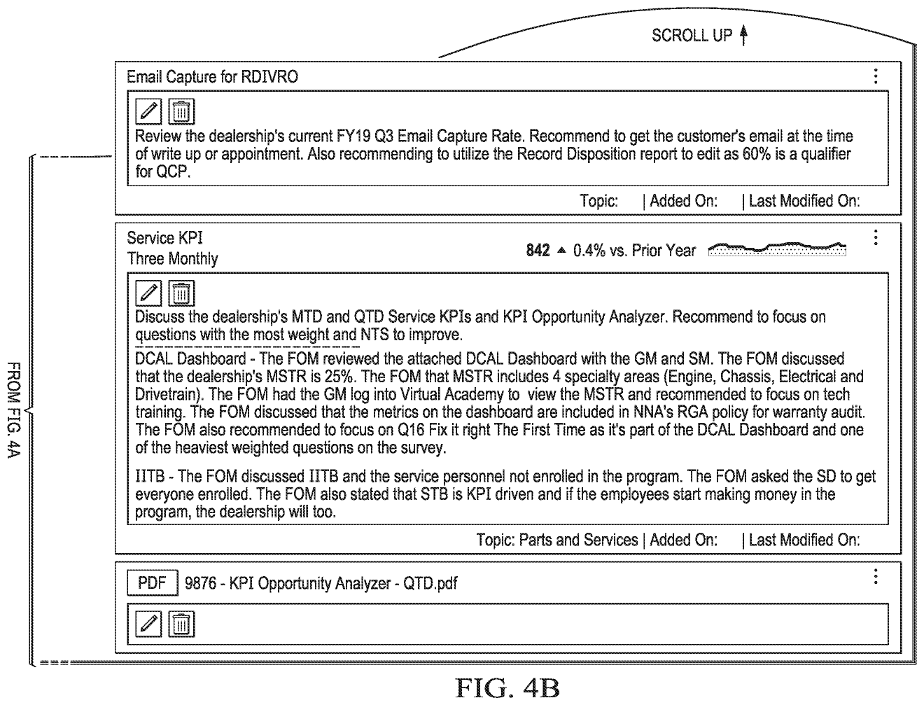

Additionally, the set of users who have created a visit agenda 220 for the outlet may be further refined by their perspective definition 286 so they share at least one perspective attribute with the user creating the current visit agenda 220, or the set of users may be ranked based on such perspective attributes. This set of users who have created visit agendas 220 for the same outlet may be presented to the user through the visit agenda interface 250 to allow the user to view (e.g., but not edit) the visit agenda 220 created by these other users for the same outlet. FIG. 5 depicts one embodiment of an interface for the creation of a visit agenda. Here, in area 502 a menu (e.g., a drop down menu) is depicted which allows the selection of other users of the organization that have created visit agendas that may be viewed.

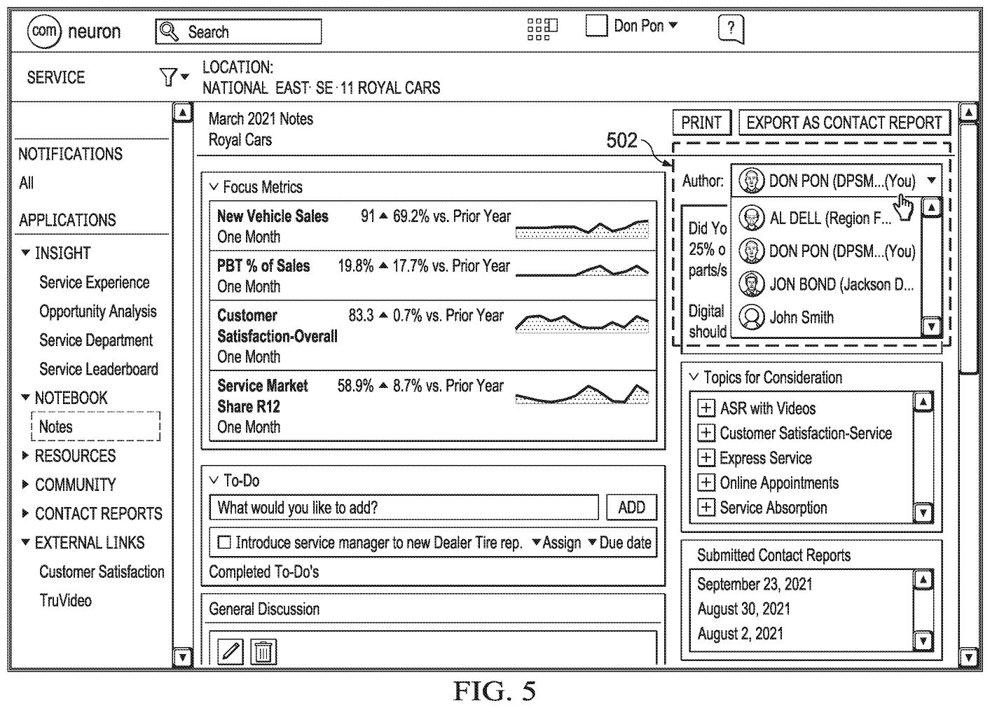

The collaborative platform 110 may also create and present a focus metric visit agenda item 224 comprising a set of focus metrics based on the specification data 290 associated with the organization 202. These focus metrics may be certain data that the organization may desire a user to discuss with an outlet and may thus be metrics 282 that the collaborative platform automatically includes in a visit agenda 220. These may be included based on user perspective (user attributes) 286. Accordingly, when the user accesses the interface 250 for creating the visit agenda 220 for an outlet, the collaborative platform 110 may access the user's perspective definition 286 to obtain the values for the perspective attributes for the user. The collaborative platform 110 can also access the data specification 290, including the focus metric parameters that define the data that a particular type of users should discuss with an outlet. Based on the perspective definition 286 of the user (e.g., the geographical indicator 288 or role of the user) and the focus metric parameters defined by the organization 202 the collaborative platform 110 can determine which data (e.g., associated with that particular outlet 206 or regions 204 in which that outlet resides), including which metrics 282 (e.g., associated with the geographic region 204 or outlet), should be included in the visit agenda being presented through the interface as focus metrics. FIG. 6 depicts one embodiment of an interface for the creation of a visit agenda. Here, in area 602 an area of the visit agenda is presented includes a focus metric agenda item determined by the collaborative platform.

The collaborative platform 110 may also create and present required visit agenda item 224 comprising a set of required items for the agenda 220 based on the specification data 290 associated with the organization. These required items may be data that the organization wants the user to discuss with an outlet (e.g., based on performance related issues or the like). The organization may desire that such items be included in the visit agenda 220 such that there can be a record that such items were discussed with the outlet and that the organization can prove or document that such items were discussed (e.g., when a contact report 270 gets created from such a visit agenda 220, as discussed). Here, when the user accesses the interface 250 for creating the visit agenda 220 for an outlet, the collaborative platform 110 may access the required issues parameters of the organization data that define the data that users must discuss and the user's perspective definition 286 (e.g., a geographical identifier 288 or role associated with a user). The values for the attributes of the user (e.g., an associated geographic region 288 or role of the user within the organization) can then be evaluated against the required issues parameters to determine which metrics 282 or other data should be included in the required items 224 of the visit agenda 220 for this user and outlet. The values for the determined metrics or data can then be determined for the outlet (or the outlet's region, etc.) for which the agenda 220 is being created and included in the visit agenda 220.

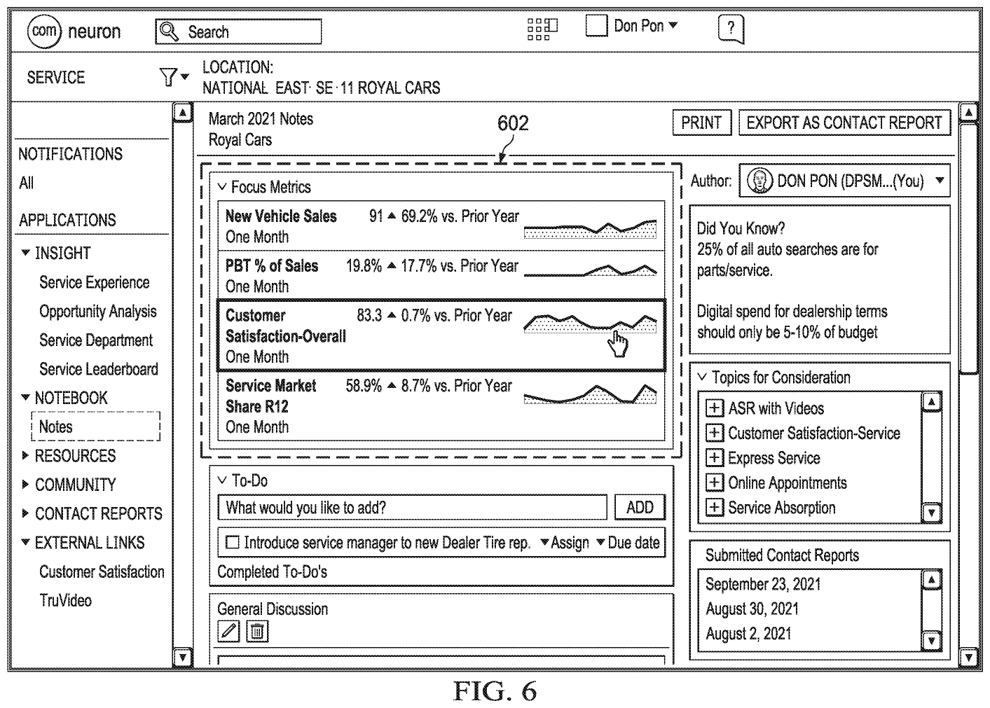

The organization's required items rules 292 may also be used to determine metrics 282 or other data to include in the required visit agenda item 224. In this case, based on the values for the perspective attributes of the user in the perspective definition 286, zero or more of the required item rules 292 specified by the organization may be determined from the organization's data 202. These rules 292 may specify one or more metrics 282 and an associated threshold or range such that the specified metric 282 meets the rule (e.g., the value of the metric falls above or below the threshold, inside or outside of the range, etc.) the metric 282 may be presented to the user or included in the required visit agenda item 224 of the visit agenda 220. The values for these metrics 282 can then be determined for the outlet (or the outlet's region, etc.) and evaluated using the corresponding determined required item rule 292. If the value of the metric meets (or doesn't meet) the rule, the metric may be included in the required visit agenda item 224 of the visit agenda 220. FIG. 7 depicts one embodiment of an interface for the creation of a visit agenda. Here, in area 702 a required agenda item is depicted.

The collaborative platform may also create and present a to do list visit agenda item 224 that may allow a user to make notes on what to do during a visit to the outlet along with associated notes. Each item in the to do list visit agenda item may be tracked and assigned or given a due date or marked as complete. Here, in area 704 of FIG. 7 a to-do list visit agenda item is depicted.

Similarly, the collaborative platform 110 may also create and present a general discussion visit agenda item 224 that may allow a user to make notes or describe what should be discussed in a visit to the outlet. This general discussion visit agenda item allows the topics of discussions in each visit to be tracked and preserved as the visit agenda evolves dynamically and is captured in contact reports. In area 706 of FIG. 7, a general discussion visit agenda item is depicted. A topics for consideration visit agenda item 224 provides a list of ‘topics’ which, when one is clicked, may add a pre-generated discussion or metric to the visit agenda 220. In area 708 of FIG. 7, a general discussion visit agenda item is depicted.

The collaborative platform may also create and present a recommended metrics agenda item 224 comprising a set of recommended metrics for the agenda 220 for that user and outlet. To determine the metrics 282 to recommend to the user in the recommended metrics agenda item 224 the collaborative platform 110 may obtain metrics 282 associated with both the outlet and the user's perspective 286 and assign a severity ranking or weight to each of the metrics 282. The severity ranking of a metric 282 may be based on a comparison of the value of that metric 282 to a threshold, a trend of the value of that metric 282, or a ranking of the value of that metric 282 for the outlet associated with the agenda 220 relative to the value of that metric 282 for other outlets of the organization (e.g., within the same geographic region 204 as the outlet 206 associated with the agenda 220). The rankings of the metrics 282 may also take into account organization data 202 indicating which of the metrics 282 are (relatively) more important to the organization. Thus, for every outlet and user perspective these recommended metrics may be ranked differently.

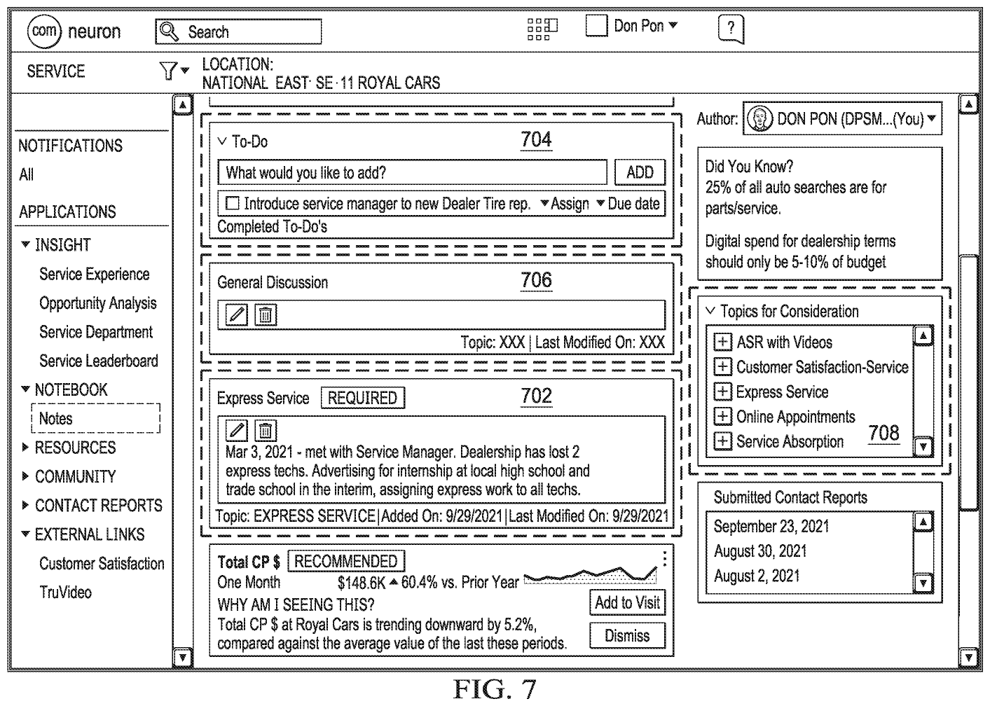

A top (or bottom) ranked set of these ranked metrics (e.g., the top or bottom ranked two or three metrics) may then be presented in the recommended metrics agenda item 224 of the visit agenda 220 when the visit agenda is presented in the interface 250. There may also be a textual description indicating why that metric 228 was presented in the recommended metrics agenda item (e.g., such as “this outlet ranked in bottom 25^{th} percentile for his metric”). A user may be presented with the ability to dismiss presented recommended metrics 282 or to obtain new recommended metrics 282, whereby the recommended metrics 282 may be presented to the user in the recommended metrics agenda item 224 in order of the rankings (e.g., when a recommended metric is dismissed by a user the next recommend metric in the rankings may take its place). The user may be given the capability to add these recommend metrics 282 to the visit agenda 220, however, if the user takes no action or does not otherwise indicate a desire that the recommended metrics 282 become part of the visit agenda 220 they may not be added to the visit agenda 220 stored at the collaborative platform 110. In some embodiments, the recommended metrics 282 for the recommended metrics agenda item 224 may be determined using a machine learning algorithm or the like that evaluates the metrics to determine metrics that are outliers or trending in certain manners that have not been identified in other outlets. FIG. 8 depicts one embodiment of an interface for the creation of a visit agenda. Here, in area 802 an area of the visit agenda is presented includes a recommended metrics agenda item.

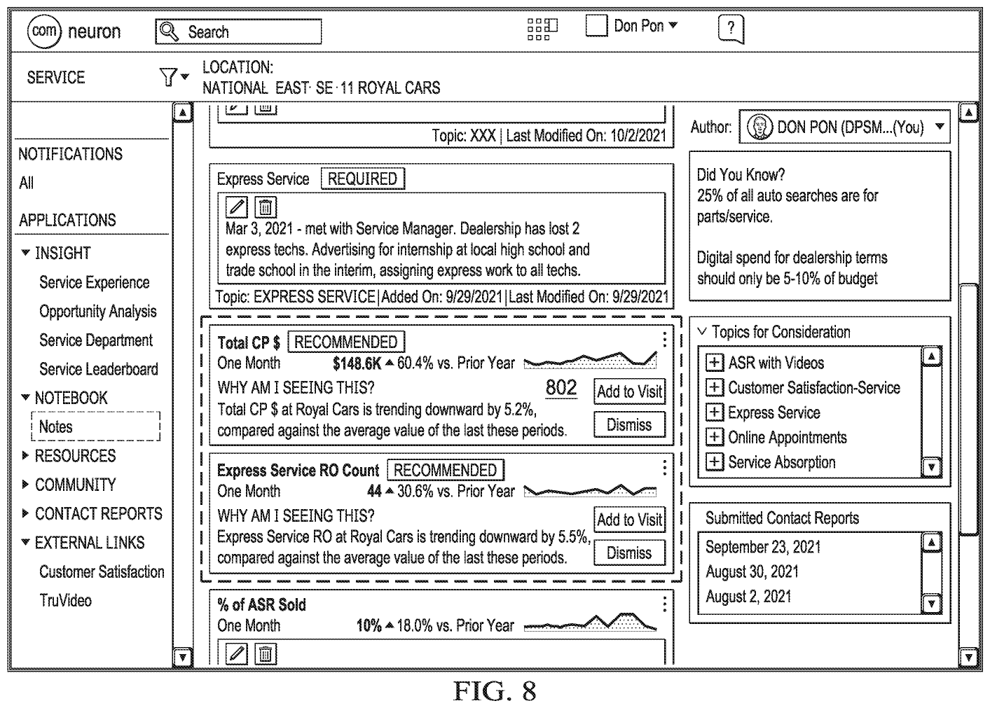

The user interface 250 of the collaborative platform 110 may also provide the ability to add metrics 282 presented or accessed in other areas of the collaborative platform 110 to a visit agenda 220 in an easy in straightforward manner. For example, FIG. 9 depicts one embodiment of an interface that may be provided by a collaborative platform 110 to allow a user to access various metrics in a “dashboard” or other interface associated with an outlet or region. An icon or other interface area 902 may be activated in association with these presented metrics 282 to add the presented metric 282 directly to a visit agenda item 224 of a visit agenda 220 associated with the outlet (e.g., associated with the presented metric 282), despite that the user in not accessing the visit agenda 220 for that outlet directly through the interface.

As a particular workflow scenario for embodiments of collaborative platform 110 where such a dashboard may be particularly useful, suppose a user (e.g., such as a district or regional manager or the like) is preparing for her first visit to an outlet, and creates a visit agenda 220 for the outlet at that first time. This user can review the dashboard to select metrics associated with that outlet (or the region in which the outlet is situated) and add those metrics directly to the visit agenda 270 being created. The user can then conduct a visit (e.g., a physical or virtual meeting) with the outlet (e.g., a representative for the outlet such as a manager, proprietor, or other person or people affiliated with the outlet) using the visit agenda 270 for that outlet created at the first time. Once this first visit with the outlet is conducted, the user can create (e.g., a submit) contact report 270.

Subsequently, when the user is preparing for another visit to the outlet at a second time (e.g., a second visit) that same user can not only access the previously created visit agenda 270, where the data (e.g., metrics 228) may have been updated in the visits agenda 270 between the first and second time, but can additionally review any notes made, and the previously created contact report 270. Moreover, the user can again review the dashboard to select metrics associated with that outlet (or the region in which the outlet is situated) and add those metrics directly to the visit agenda 270 (e.g., the visit agenda being edited for the second visit). As the data presented in such a dashboard may have been updated between the first time and the second time with the most pertinent and up to date data (e.g., metrics) for that outlet at that second time (which may be substantially different metrics or values than the most pertinent metrics at the first time), the use of such a dashboard in conjunction with a collaborative platform 110 for the creation of visit agendas provides a simple and straightforward way to view, access, and add the most current and pertinent data to visit agendas at the very time those visit agendas are being composed or edited.

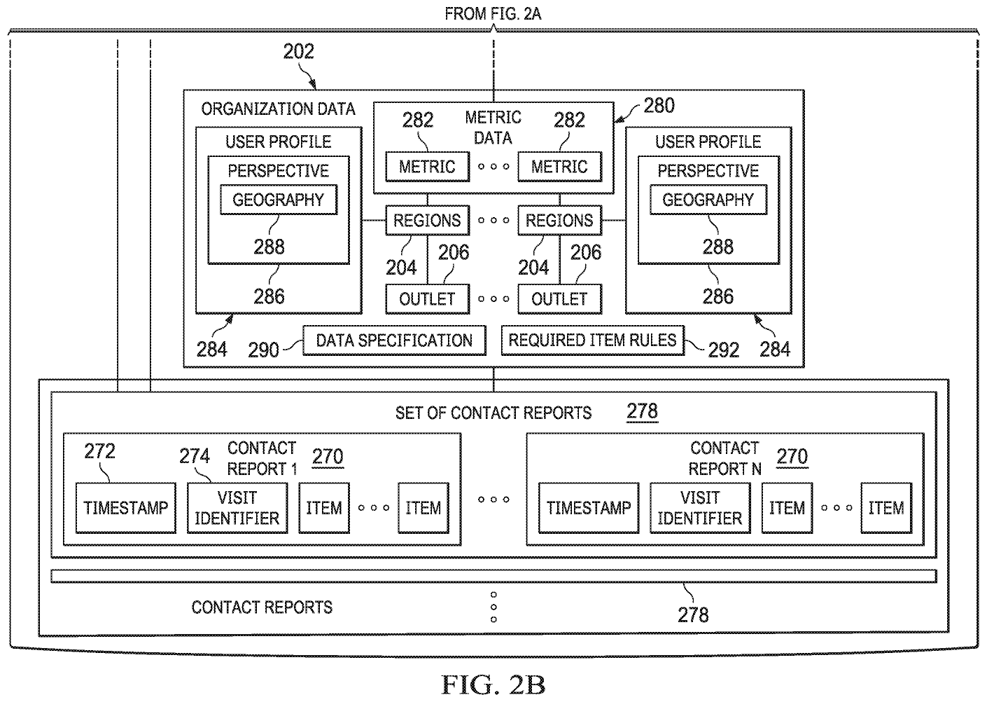

Referring to FIG. 3, a flow diagram illustrating a method for creating and using a visit agenda document using a collaborative platform in accordance with some embodiments is shown. In this embodiment, a field team user initially creates a visit agenda document on the collaborative platform (302). In response to a request from the user to create a visit agenda document, the collaborative platform creates a container corresponding to the visit agenda document. This container will be used to contain various sub-containers corresponding to individual visit items that are created or selected by the user for inclusion in the agenda document. After the visit agenda document has been created, the collaborative platform presents to the user one or more suggested items that may be included in the agenda document (304). These items may include any type of item that may be contained in an agenda document, such as one of the metrics created by the analytics engine, an item designated as a regional initiative by a management user, text documents images, emails, or any other suitable items. The field team user may select one or more of the items presented by the platform, or may separately select or create items for inclusion in the agenda document (306). The items that are included in the agenda document may be accessed by the field team user, a user of the outlet associated with the agenda document, or a management user (308). The access of each of these users may be controlled according to rules associated with the type of user, or the specific identity of the user (e.g., a person associated with a specific outlet of the organization may have read access to items in an agenda document with which the outlet is associated, but may have no access to agenda documents with which the outlet is not associated). These actions represent the collaborative creation of the visit agenda document.

After the visit agenda document has been created, it is stored, and is used as the basis for discussions between the field team and the outlet representatives, and the visit agenda document may be updated according to the discussions (310) (e.g., the field user may add notes to the visit items in the document, or the outlet representative may provide responses or comments associated with the visit items. After the visit has been completed, the field team user may initiate the creation of one or more contact report based on the visit agenda document (312). The collaborative platform automatically retrieves information from the electronically stored agenda document and generates the contact reports using this retrieved information. The generated contact reports are archived in a data store of the collaborative platform, where they can be accessed by users such as the field team user and management users who have access to the reports (314).

Here it may be useful to discuss embodiments of how the data to present in particular visit agenda items may be determined. Referring back to FIGS. 2A-2B then, embodiments as disclosed include systems and methods for providing recommended metrics to a field team (e.g., a regional manager) for the development of a visit agenda for discussion with an outlet of the organization in the course of managing the outlet. As discussed, these systems and methods are implemented in a collaborative platform which is used by the field team to develop the visit, which may include one or more visit agenda items that can be accessed not only by the field team developing the visit, but in certain embodiments, the outlet that is the subject of the visit and higher-level users of the organization.

As also discussed herein, the collaborative platform 110 integrates various tools and processes needed by the field team into a single platform that facilitates the creation and integration of the items in the visit agenda 220. These tools and processes are used to make the visit agenda 220 more consultative and effective by, e.g., incorporating data, action planning, and human-generated content into the field team's workflow. With the collaborative platform 110, the field team have all the needed tools in one place, so they can pull information directly from their notes, data, reports and other resources to incorporate the information into the visit agenda 220. The use of the collaborative platform 110 allows the workflow associated with the visit to be more structured, so that the field team can develop, present and follow up the visit in a more organized and efficient way than was previously possible.

Accordingly, one of the tools that is provided in the collaborative platform is a recommended metrics engine 254 which is adapted to use analytics to determine which of a potentially vast number of available metrics 282 are the most pertinent to the visit agenda 220, and to present the identified metrics 282 to the field team for potential inclusion in a visit agenda 220. The recommended metrics engine 254 is adapted to automatically select from all (or some subset) of the available metrics 282 using complex criteria based on up to date data, which is, as a practical matter, beyond the capabilities of even expert users. While field team users may select metrics 282 based on their own knowledge, experience and insight, the recommended metrics engine 254 allows them to do so in a manner which is more thorough and efficient, and is based on more current information.

As noted above, the volume of available metrics data and the frequency with which the data is generated and updated is so great that the field teams cannot keep pace, and cannot make well-informed decisions regarding the best metrics 282 to include in the visit agenda 220 for a visit. Previous solutions for this problem were inadequate because of their simplicity and inflexibility. One of the existing methods to use data to identify high-priority metrics which is very common is to use static thresholds. For instance, performance below 70% might be used to turn a metric red to attract attention, or conditional formatting might use relative values within a set to identify which ones are the highest or lowest performers. This works well for small sets of data, but as the number of metrics grows (e.g., exceeds 1000) the percentage that exceed their thresholds inevitably become too many for a user to interpret correctly. Moreover, the simplistic thresholds give the user no indication that specific metrics may be approaching a threshold (rather than having already crossed the threshold) and requires immediate attention.

Another existing method is the application of a user's specific domain knowledge, in the form of manual selection of metrics on a dashboard. The first time the dashboard is created, the domain expert may be able to prioritize the metrics, but this method cannot automatically scale to address the minute-by-minute adjustments in metric values and trends.

To address these inadequacies, among other ends and advantages, embodiments of a recommended metrics engine 254 use analytics which combine data science and electronically represented domain knowledge to determine the relative priorities of metrics 282 in a data store 240 for the purpose of bringing to the attention of a user metrics 282 that have a high priority or are otherwise important or germane with respect to a specific outlet. The recommended metrics engine 254 uses algorithms to identify important metrics 282, and integrates with the workflow of the collaborative platform 110 to bring these metrics to the user's attention through the user interface 250 in a way that is noticeable and actionable. Generally speaking, the importance of the metrics 282 may be determined in embodiments by how far away the metrics are from the organization's expectations. The farther a metric 282 is away from the associated expectation, the higher rank it would receive in embodiments of a prioritization performed by recommended metrics engine 254 which would then make it more likely to be recommended by the recommended metrics engine 254.

Embodiment of the recommended metrics engine 254 provides a number of advantages over the prior art. For example, they may combine algorithmic processes of the recommended metrics engine 254 with encoded expertise to identify important metrics, which is an improvement over methods that rely exclusively on human knowledge. As another example, recommended metrics engine 254 does not rely on a static definition of what makes a metric “important,” which makes the recommended metrics engine 254 more flexible in identifying metrics within a dynamic data environment than either static thresholds or manual prioritization by humans. As yet another example, the recommended metrics engine 254 can be integrated into users' daily workflows via the collaborative platform 110, ensuring that those metrics 282 which are identified as important by the system are actually seen by the user, and can be acted upon by the user.

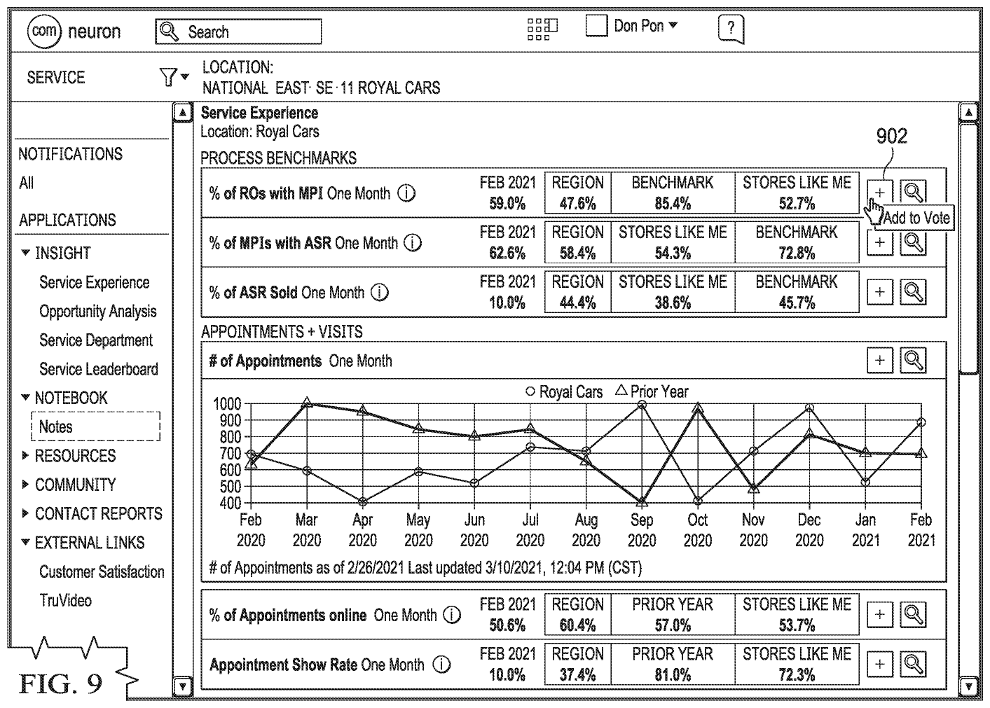

Moving now to FIG. 10, a diagram illustrating recommended metrics engine 254 in accordance with some embodiments is shown. As depicted in this figure, metrics data 282 is provided to recommended metrics engine 254, which has components to load configuration information, check the metrics data 282 according to the configuration information, prioritize the metrics data that passes the checks, and format a set of selected (more highly prioritized) metrics 282. The set of selected metrics may then be stored or then provided to the user (e.g., in a recommended metrics visit agenda item) so that the user can select one or more of the metrics 282 for inclusion in the visit agenda 220. In one embodiment, the pipeline of the recommended metrics engine 254 is written in Python scripting language.

The recommended metrics engine may provide a number of features, such as:
User feedback loops, which may combine a dismiss or save action for a metric 282 received through the interface 250 when a user interacts with a presentation of a recommended metric visit item with information about an outlet's performance to prioritize the recommended metrics 282 or sustain suppressed display for bottom performers.
Optimizing the configuration of recommended metrics.
The use of competition algorithms, which especially prioritize “2nd-best” recommendations (recommendations where the outlet is “2nd-best” and could be encouraged to try to be best).
Extending the recommendations to selected items in the topics for consideration visit agenda item which management users associated with the organization have elevated in importance.
Recommending positive trends to acknowledge top performers for a metric 282.
Recommending “Related Metrics” that have been identified by quantitative and qualitative analysis of the metric 282 or data used to determine such a metric 282.
Displaying recommended metrics 282 in workflows other than the development of visits agendas 220 such as changes to dashboards or the introduction of alert communications (such as emails or texts).
Recommending metrics based on the behavior of the current (field team) user or other similar users.
Alerting the user to any metric changes (which typically occur after an associated leading event).

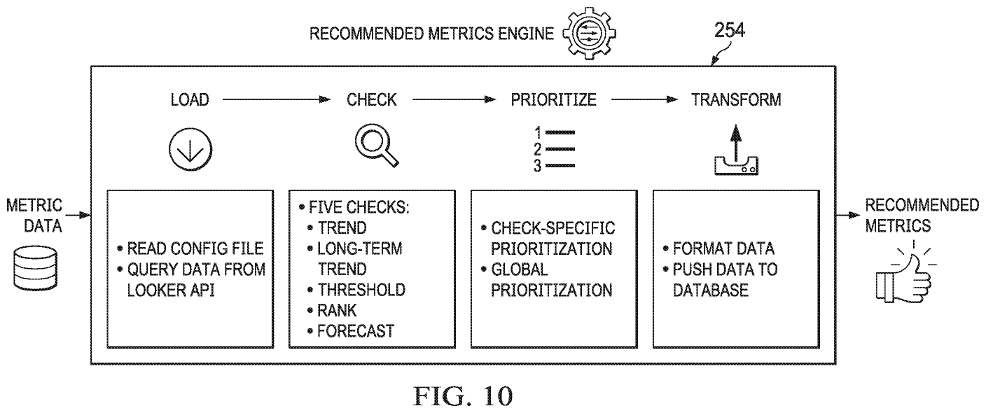

Referring now to FIG. 11, a flow diagram illustrating an one embodiment of a method for examining the metrics data and selecting one or more of the metrics to recommend to the user that may be employed by an embodiment of a recommend metrics engine is shown. Initially, a configuration (e.g., a configuration file) may be read at the “Load” step. Such a configuration file may specify the metrics to be checked and the type of the checks to be applied (1102). The configuration also includes the specifications that inform the pipeline where to retrieve the metric data and which organizations and associated users can see the recommended metrics through an interface of the collaborative platform. As users may be grouped by their position, roles or titles (e.g., as part of their perspective definition), the configuration file may be created per user group (e.g., per organization). However, because each organization may have a number of user groups, creating and maintaining the configuration files may be a laborious process. In some embodiments, an approach is therefore used for managing the configuration files whereby the user-role specific configurations can be consolidated into one per organization, and utilizes a serialized file format such as a JSON file format or YAML file format. The resulting configuration files may thus be more concise, more flexible, and more maintainable.

Metric data is queried (e.g., through an API associated with a data store or another interface) based on the specifications of the configuration files. Once the data is read, several checks may be performed against the data according to the configuration files (1104). These checks may include:

1. Detect a downward trend of a metric. For example, the recommended metric engine may look back at the five previous reporting periods of the metric, if the metric value of the current period is worse than the average of the metric value in the past three reporting periods, and the latter is worse than the average of the metric value in the past five reporting periods, then this downward trend is flagged to alert users or to rank the metric relative to other metrics that may be evaluated for presentation to a user.

2. Acknowledge outlets with an upward trend on a metric. The upward trend can be defined as a scenario when the metric value of a current period is better than the average of the metric value in the past three reporting periods (e.g., for an outlet), and the latter is better than the average of the metric value in the past five reporting periods.

3. Detect when a metric value falls behind (e.g., above or below) a certain threshold. This type of check may be enhanced by expanding the single value of the threshold to a range. Not only may a metric value that is above or below a certain threshold be detected, but additionally, if a metric value exists within a range (e.g., a preconfigured range or the like) it may also be used to rank the metric for presentation to a user. This allows users to be alerted that if a metrics value falls out of a “sweet spot,” or is in a “danger zone, etc.

4. Detect a long-term (e.g., over some defined period of time) downward trend. Because some metrics such as sales and traffic vary seasonally, removing seasonality from the data allows may allow a long term trend to be recognized or determined. Applying a time series decomposition model, the history of the metrics values can be decomposed into two parts: seasonality and trend. The recommended metrics engine may only evaluate the trend part of the data. Then the same method may be used to detect the downward trend as discussed herein.

5. Detect changes in rankings of an outlet. The recommended metric engine may also detect whether the rank of outlets in (e.g., a user's) geographic area (region) for a particular metric is out of normal range. In some embodiments, the boundary of the normal range may be defined as the 20th and 80th percentile of their ranks in the past.

Because such checks may be implemented on the outlet and metric level, multiple metrics might be ranked or flagged for each outlet. For this reason, ranking algorithms may be utilized to prioritize the metrics per outlet (1106). For example, each of the check types described may utilize a key metric for ranking. In some embodiments, the key metric for the check to detect a downward trend is the percentage change between the metric value of the current reporting period and the average of the metric value in the past three reporting periods. As an example, the higher the percentage change of the metric, the higher rank it would receive. The key metric for the check to detect whether a metric value falls behind a certain threshold is the percentage difference between the metric value and the threshold. Though the ranking algorithm within each type of checks is well defined, the ranking algorithm among each type of checks may be arbitrarily defined. For example, a “Z score” ranking method may be utilized to address this issue. Z score is the number of standard deviations by which the value is far away from the mean. Because each ranking key metric has its distribution, the Z score may be calculated per outlet and metric based on the sampling distribution of each ranking key metric. Since the Z score has the same meaning across different sample distributions, it can be compared among the ranking key metrics, and therefore the metrics can be prioritized among the ranking key metrics.

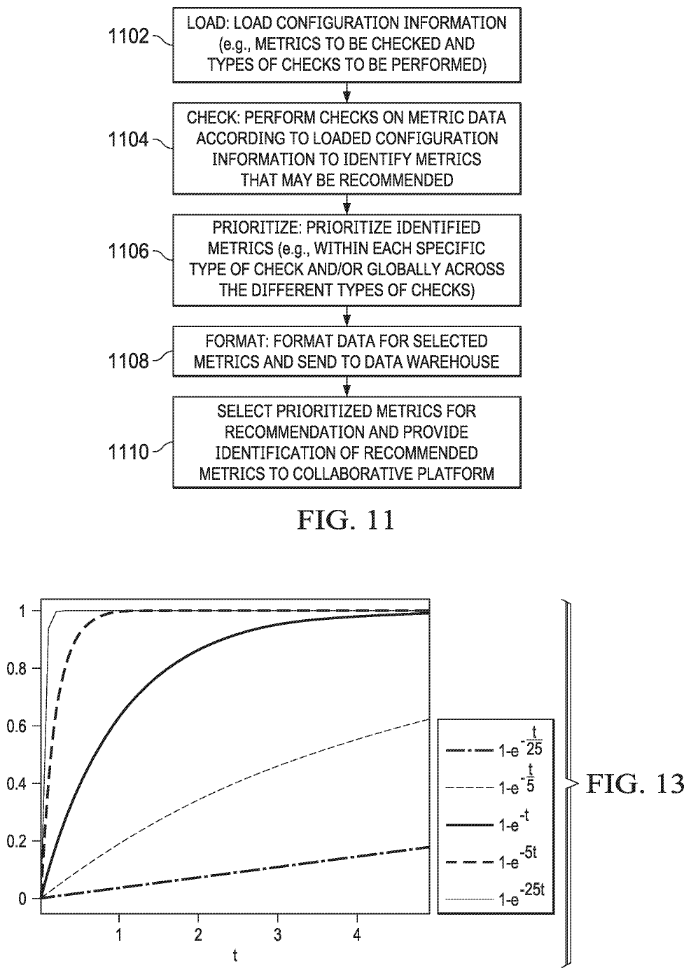

Referring to FIG. 12, a graphic depiction of an example of recommended metrics prioritization in accordance with some embodiments. For simplicity, all the metrics mentioned in this example are considered to be “better” if they have higher values, counted by units, though as may be realized such prioritization may be similarly accomplished if such metrics are considered to be “better” if they have lower values. The configuration file may specify that the trend check is applied to Metric 1-Metric 5, and the threshold check is applied to Metric 6-Metric 10. So for Metric 1-Metric 5, the average in the past three and five reporting periods (r3 and r5) per outlet is computed. By comparing it with the score in the current reporting period (r1), a metric for Store (outlet) A will be recommended if r5 is larger than r3, and r3 is larger than r1 because it indicates a downward trend. Table 1 shows r5, r3, and r1 of Metric 1-Metric 5 for Store (outlet) A. For Store (outlet) A, r5, r3, and r1 of Metric 1 are 85, 76, and 50 correspondingly. Because r5>r3 and r3>r1, Metric 1 will be recommended to Store A. The key metric for the trend check is the percentage change of the score in the current period compared to the average in the past three periods. It is calculated as (r1−r3)/r3. The percentage change of Metric 1 is −0.34 in this example. That means the score of Metric 1 for Store (outlet) A has decreased by 34% compared to the average in the past three reporting periods. Then the Z score of the key metric, the percentage change, is calculated as the number of standard deviations away from the average. The population distribution of the percentage change is different across the metrics because one metric can trend up, and the other metric can trend down nationally. As a result, it is necessary to calculate the Z score per metric. Table 3 shows the percentage changes for all five stores, which are the population in this simple example. The mean and standard deviation of the population is −0.31 and 0.31. Thus, the Z score of the percentage change on Metric 1 for Store (outlet) A is −0.1, as shown in the calculation below.

$$Z score = \frac{score - mean}{standard deviation} = \frac{- 0.34 - ( - 0.31 )}{0.31} = - 0.1$$

Following the same way, all the Z scores of percentage change on Metric 2-Metric 5 for Store (outlet) A can be calculated. Back to the other type of check, threshold check, the metric will be recommended if the score in the current reporting period (r1) is less than the threshold (t). The key metric in this example is the percentage difference between r1 and t. It is calculated as (r1−t)/t. As is shown in Table 2, r1 and t of Metric 6 are 89 and 90 for store (outlet) A. Since r1 is less than t, Metric 6 may be recommended. As its percentage difference is −0.01 that means the score of Metric 6 for Store (outlet) A is 1% lower than the threshold. Similarly, the Z score of the percentage difference is calculated per metric, as it is demonstrated in Table 4. Finally, all the metrics that will be recommended for Store (outlet) A across different types of checks are placed together. They are ordered by their Z scores. In this sample, since Metric 8 has the lowest negative Z score, it receives the highest rank, and it will be on the top of the recommendation list for Store (outlet) A.

After the metrics are prioritized (ranked), the metric data are formatted and then sent to the data warehouse (1108) or to the user interface for presentation to a user in a visit agenda interface such that that users can see the recommended metrics in a recommended metrics visit agenda item on an interface of the collaborative platform (1110). Each recommended metric may, for example, be presented as shown in area 802 as depicted in FIG. 8.

A number of additional enhancements may also be implemented in particular embodiments of a recommended metrics engine. One of these is integrating user feedback to prioritize recommended metrics. If a user clicks “dismiss” or takes another action to make a recommended metric go away (e.g., as described above with respect to a user interaction with a recommended metrics visit agenda item in a user interface), that metric will be deprioritized for this user in the ranking algorithm, so that the particular user is less likely to see the same metric in the future. The prioritization of the recommended metrics is conducted per outlet and user (e.g., user perspective such as title, role, etc.) because users with different positions within the organization may care about different metrics. Typically only one user per title or role is assigned to an outlet. The prioritization may be determined by the Z score method that is discussed above. The user feedback may be used to adjust those Z scores with the help of the exponential decay function. Below is one formula that may be used for the adjustment.

$$Adjusted Z score = \{ \begin{matrix}Z score * ( 1 - {e}^{( - at )} ) & 0 < t < T \\ Z score & t \geq T\end{matrix}$$

where t is the number of the reporting periods between the current reporting period and the reporting period when the user clicked the “Dismiss” button on the recommended metrics. When t=0, it indicates that the user dismissed the metric in the current reporting period. These recommended metrics will be removed from the recommendation list. Tis the maximum value of t where the Z score needs to be adjusted. When tis above T, no adjustment is needed. When t is below T, however, the Z score is multiplied by an adjustment factor (e.g., which ranges from 0 to 1, or may take some other value depending on the adjustment desired).

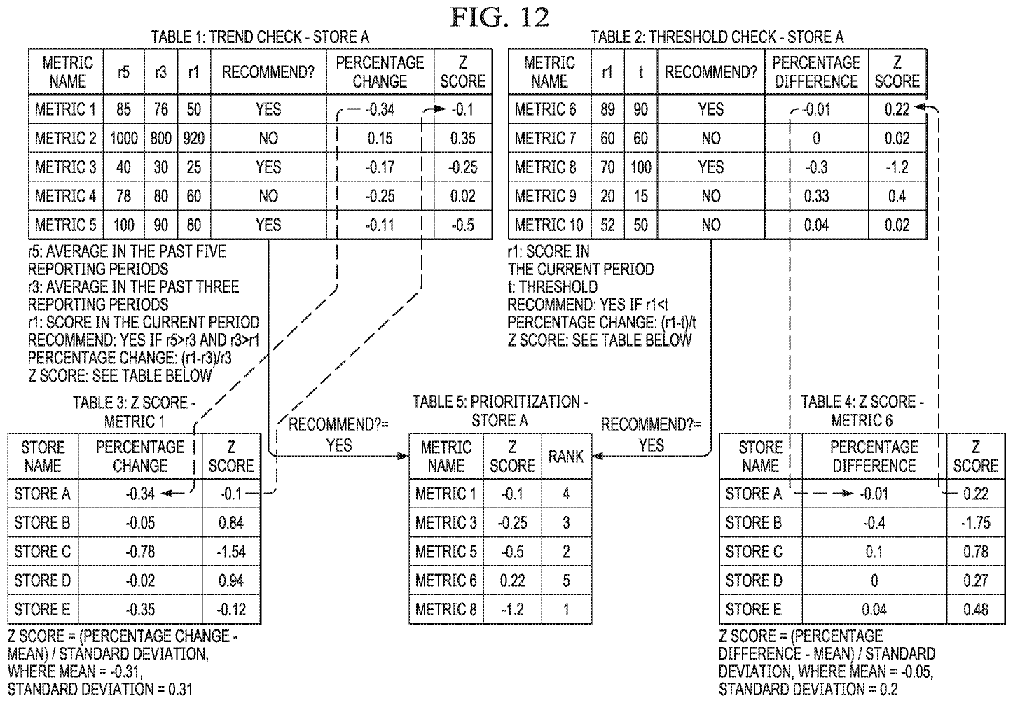

FIG. 13 shows a chart that depicts that the adjustment factor gets larger as t increases. How fast the adjustment factor approaches to 1 depends on the decay parameter a. This parameter can be tuned based on how soon the user preference might change. In short, the Z score of a recommended metric for a particular store and user perspective (e.g., role or title) is penalized if a user dismissed this metric. The penalty is heavier in the beginning and may be gradually lightened as time goes by until it reaches a limited time period.

In some embodiments, an enhancement to the recommended metrics engine that can be implemented is to tune the recommended metrics algorithm for a specific user based on other users' behavior. For example, users with the similar perspective attributes (e.g., a role, title or position within the organization) are typically interested in the same subset of metrics, so the metrics for the user that are popular in her peer group can be prioritized (e.g., a group of users may all belong to a “service” role and may be interested in similar metrics). Based on how often the recommended metrics are saved to a visits page for a group of similar users, the popularity scores of the metrics for this group can be computed.

One way to calculate the popularity score of a metric for a user group is to take the log transformation of the occurrences when this metric is saved by a user in this group (e.g., a group of users defined by sharing at least one perspective attribute, such as a role, group or position within the organization) during a certain amount of time, such as 30 days, and scale it to a range of 0-1 by dividing the maximum of the log transformation of the saving occurrences among all the metrics. An exemplary formula is shown below. The reason to use the log transformation is the distribution of saving occurrences are very skewed. In other words, only a very few metrics have a high saving occurrence, and the majority of the metrics have low saving occurrences. This is similar to the number of online ratings on movies. The log transformation can help to alleviate the skewness.

$$Popularity {Score}_{i} = \frac{log ( saving {occurrences}_{i} )}{{max}_{i ∈ l} log ( saving {occurrences}_{i} )}$$

After the Popularity Score of a metric is calculated, it can be applied to the Z scores of this metric on the prioritizing stage. The magnitude of Z scores will be shrunk by the Popularity Scores that are from (for example) 0 to 1. In some cases, the Z score of the metric with the highest number of saving occurrences will not be impacted by the Popularity Score, while the Z score of the metric which almost no users saved will be heavily penalized by the Popularity Score.

In some embodiments, a recommended metrics engine may be enhanced to recommend related metrics (e.g., related to a recommended metric). For example, instead of recommending one metric, the recommended metrics engine can add (e.g., recommend) the metrics that are associated with a recommended metric. In one embodiment, the additional metrics (referred to as related metrics), may be determined by using one or more of the following criteria:

1. Metrics that are mathematically correlated with the recommended metrics. This process relies on calculating the Pearson Correlation for the pairs of metrics and filtering the metrics that have the strongest correlation with the metric that is recommended. Because The Pearson Correlation is calculated on a metric base with the metric data of the collaborative platform, given a recommended metric, its highly correlated metrics can be identified by sorting its correlation coefficient with other metrics in descending order and selecting the top-ranked (e.g., top two or three) metrics.

2. Spuriously correlated metrics may be excluded based on domain knowledge. A major cause of the spurious correlations is that two events have common causes. For example, the suicide rate has a strong correlation with US spending on science over time. It is not because increasing US spending on science causes a higher suicide rate or vice versa. Instead, it is the economic situation that caused both of them. Some embodiments may use expertise or domain knowledge to identify the spuriously correlated metrics. This domain knowledge may be encoded electronically, such that these spuriously correlated metrics may be removed. Alternative, highly correlated metrics are generated, they may be sent to users to review and eliminate spuriously correlated metrics. The final set of related metrics may be stored for presentation to a user.

3. Related metrics may be actionable so that they can provide a clear guide to users for any improvement. This improvement may be a process that is driven using domain knowledge. If a metric is actionable, it means users know how to drive up this metric and this metric can be improved within a certain amount of time (e.g., two or three months) if certain actions (e.g., best practices) are applied. For example, a customer satisfaction index that is calculated based on the answers to dozens of survey questions is considered not actionable. But the answers to a specific question included in the survey, such as “whether you are greeted in the store”, is actionable. Because the customer satisfaction index is an aggregated metric, users do not know exactly how to improve this metric effectively. In contrast, the answers to a specific question in the survey include all the information that users need to know to improve the survey result in the future. One major use case of related metrics is that users can understand how to drive up (or down) a recommended metric by working on their related metrics. Therefore, the related metrics should be actionable. The judgment of the actionability of metrics is based on domain knowledge. Whether a metric is actionable may be stored in association with definition of the metric.

A recommended metrics engine may also recommend positive trends to acknowledge top performers (e.g., top ranked outlets for that metric). The positive trend is determined in a manner similar to negative trends, as discussed above. For example, to determine the positive trend, the average in the past three and five reporting periods (r3 and r5) per outlet is determined. By comparing these with the score in the current reporting period (r1), a metric for an outlet (e.g., store A) can be recommended if r5 is less than r3, and r3 is less than r1 because this indicates a positive trend.

A recommended metrics engine may also introduce competition in the recommendations determination process. One of the possible approaches is to prioritize “2nd-best” recommendations. By this approach, a set of rankings on a metric to be recommended are calculated for a particular outlet, such as district rank or region rank. If an outlet is ranked as the second place in its district or region, a recommendation of this metric may be recommended for in a recommended visit agenda item for a user associated with the outlet such that it can be presented to an outlet to, for example, encourage the outlet to pursue the top place.

Embodiments of the technology may be implemented on a computing system. Any suitable combination of mobile desktop, server machine, embedded or other types of hardware may be used. One exemplary embodiment may be implemented in a distributed network computing environment. The computing environment in this embodiment may include a client computer system and a server computer system connected to a network (e.g., a local area network (LAN), a wide area network (WAN) such as the Internet, mobile network, or other type of network or combination thereof). The network may represent a combination of wired and wireless networks that network computing environment may utilize for various types of network communications.

The computer systems may include, for example, a computer processor and associated memory. The computer processor may be an integrated circuit for processing instructions, such as, but not limited to a CPU. For example, the processor may comprise one or more cores or micro-cores of a processor. The memory may include volatile memory, non-volatile memory, semi-volatile memory or a combination thereof. The memory, for example, may include RAM, ROM, flash memory, a hard disk drive, a solid-state drive, an optical storage medium (e.g., CD-ROM), or other computer readable memory or combination thereof. The memory may implement a storage hierarchy that includes cache memory, primary memory or secondary memory. In some embodiments, the memory may include storage space on a data storage array. The client computer system may also include input/output (“I/O”) devices, such as a keyboard, monitor, printer, electronic pointing device (e.g., mouse, trackball, stylus, etc.), or the like. The client computer system may also include a communication interface, such as a network interface card, to interface with the network.

The memory may store instructions executable by the processor. For example, the memory may include an operating system, a page editing or processing program (e.g., a web browser or other program capable of rendering pages), a server program configured to extend the functionality of the page processing program or other server code. Further, the memory may be configured with a page processable (e.g., capable of being rendered by) by the page editing program. The page may be the local representation of a page, such as a web page, retrieved from the network environment. As will be appreciated, while rendering the page, the page editing/processing program may request related resources, such as style sheets, image files, video files, audio files and other related resources as the page is being rendered and thus, code and other resources of the page may be added to the page as it is being rendered. Application server code can be executable to receive requests from client computers, generate server page files from a set of page assets (e.g., complete web pages, page fragments, scripts or other assets) and return page files in response. A page file may reference additional resources, such as style sheets, images, videos, audio, scripts or other resources at a server computer system or at other network locations, such as at additional server systems.

According to some embodiments, a network environment may be configured with a page such as a web page which is configured to launch and connect to an instance of the server program. The page may include a page file containing page code (HTML or other markup language, scripts or code), stored or generated by the server computer system, that references resources at the server computer system or other network locations, such as additional server computer systems. The page file or related resources may include scripts or other code executable to launch and connect to an instance of the server program.

Those skilled in the relevant art will appreciate that the embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any, hardware system, hardware mechanism or hardware component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein, including R, Python, C, C++, Java, JavaScript, HTML, or any other programming or scripting code, etc. Communications between computers implementing embodiments can be accomplished using any electronic, optical, radio frequency signals, or other suitable methods and tools of communication in compliance with known network protocols.

Any particular routine can execute on a single computer processing device or multiple computer processing devices, a single computer processor or multiple computer processors. Data may be stored in a single storage medium or distributed through multiple storage mediums.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A collaborative platform for the development of a visit agenda document, comprising:
a processor,
a data store, storing data on
a set of users, each user associated with a perspective definition, the perspective definition comprising a role attribute and a geographic indicator associated with one of a set of geographic regions;
a set of outlets, each outlet associated with at least one of the set of geographic regions;
a set of visit agendas, each visit agenda associated with a corresponding outlet and user of the set of users and comprising a set of visit agenda items;
a set of metrics, each metric associated with one of the set of outlets or one or more of the set of geographic regions, where each of the set of metrics is updated at an interval;
a non-transitory computer readable medium, comprising instructions for:
presenting a first visit agenda interface for a first user, the first visit agenda interface adapted to allow the first user to access a first visit agenda for a first outlet associated with the first user at a first time, where the first outlet is one of the set of outlets determined based on the perspective definition of the first user;
determining a set of visit agenda items for the first visit agenda for the first outlet associated with the first user, where a first visit agenda item of the set of visit agenda items for the first visit agenda comprises a set of metrics selected for the first visit agenda item based on the first outlet and the perspective definition associated with the first user;
receiving a user selection of one or more metrics of the set of metrics in association with a user interaction of the first user with the first visit agenda item of the first visit agenda;
storing the first visit agenda comprising the set of visit agenda items, including the first visit agenda item comprising the one or more metrics of the set of metrics; and
dynamically updating the first visit agenda, including dynamically updating the first agenda item in the first visit agenda by updating the one or more metrics of the set of metrics of the first agenda item as the one or more metrics is updated in the data store.

2. The system of claim 1, wherein the instructions are further for:
determining a second user associated with the outlet and having a second visit agenda associated with the second user stored in the data store, and presenting the second user to the first user in the visit agenda interface, such that the first user can access the second visit agenda associated with the second user.

3. The system of claim 1, wherein the instructions are further for:
storing the first visit agenda as a first contact report associated with a second time, wherein the first contact report comprises a value of the first visit agenda item, including the one or more metrics, at the first time.

4. The system of claim 1, wherein dynamically updating the first visit agenda comprises:
determining that the first user is accessing the first visit agenda at a third time;
determining that the one or more metrics has been updated since the first visit agenda was stored; and
dynamically updating the first visit agenda before presenting the first visit agenda to the first user at the third time based on the determination that the one or more metrics has been updated.

5. The system of claim 4, wherein the instructions are further for:
storing the first visit agenda as a second contact report associated with a fourth time, wherein the first contact report comprises a value of the first visit agenda item, including the one or more metrics, at the second time.

6. The system of claim 1, wherein the set of visit agenda items comprise one or more of a recommended metrics visit agenda item, a focus metrics agenda item, or a required visit agenda item.

7. A method for developing a visit agenda document, comprising:
storing data on a set of users, each user associated with a perspective definition, the perspective definition comprising a role attribute and a geographic indicator associated with one of a set of geographic regions;
storing data on a set of outlets, each outlet associated with at least one of the set of geographic regions;
storing data on a set of visit agendas, each visit agenda associated with a corresponding outlet and user of the set of users and comprising a set of visit agenda items;
storing data on a set of metrics, each metric associated with one of the set of outlets or one or more of the set of geographic regions, where each of the set of metrics is updated at an interval;
presenting a first visit agenda interface for a first user, the first visit agenda interface adapted to allow the first user to access a first visit agenda for a first outlet associated with the first user at a first time, where the first outlet is one of the set of outlets determined based on the perspective definition of the first user;
determining a set of visit agenda items for the first visit agenda for the first outlet associated with the first user, where a first visit agenda item of the set of visit agenda items for the first visit agenda comprises a set of metrics selected for the first visit agenda item based on the first outlet and the perspective definition associated with the first user;
receiving a user selection of one or more metrics of the set of metrics in association with a user interaction of the first user with the first visit agenda item of the first visit agenda;
storing the first visit agenda comprising the set of visit agenda items, including the first visit agenda item comprising the one or more metrics of the set of metrics; and
dynamically updating the first visit agenda, including dynamically updating the first agenda item in the first visit agenda by updating the one or more metrics of the set of metrics of the first agenda item as the one or more metrics is updated in the data store.

8. The method of claim 7, further comprising:
determining a second user associated with the outlet and having a second visit agenda associated with the second user stored in the data store, and presenting the second user to the first user in the visit agenda interface, such that the first user can access the second visit agenda associated with the second user.

9. The method of claim 7, further comprising:
storing the first visit agenda as a first contact report associated with a second time, wherein the first contact report comprises a value of the first visit agenda item, including the one or more metrics, at the first time.

10. The method of claim 7, wherein dynamically updating the first visit agenda comprises:
determining that the first user is accessing the first visit agenda at a third time;
determining that the one or more metrics has been updated since the first visit agenda was stored; and
dynamically updating the first visit agenda before presenting the first visit agenda to the first user at the third time based on the determination that the one or more metrics has been updated.

11. The method of claim 10, further comprising:
storing the first visit agenda as a second contact report associated with a fourth time, wherein the first contact report comprises a value of the first visit agenda item, including the one or more metrics, at the second time.

12. The method of claim 7, wherein the set of visit agenda items comprise one or more of a recommended metrics visit agenda item, a focus metrics agenda item, or a required visit agenda item.

13. A non-transitory computer readable medium, comprising instructions for developing a visit agenda document, including instructions for:
storing data on a set of users, each user associated with a perspective definition, the perspective definition comprising a role attribute and a geographic indicator associated with one of a set of geographic regions;
storing data on a set of outlets, each outlet associated with at least one of the set of geographic regions;
storing data on a set of visit agendas, each visit agenda associated with a corresponding outlet and user of the set of users and comprising a set of visit agenda items;
storing data on a set of metrics, each metric associated with one of the set of outlets or one or more of the set of geographic regions, where each of the set of metrics is updated at an interval;
presenting a first visit agenda interface for a first user, the first visit agenda interface adapted to allow the first user to access a first visit agenda for a first outlet associated with the first user at a first time, where the first outlet is one of the set of outlets determined based on the perspective definition of the first user;
determining a set of visit agenda items for the first visit agenda for the first outlet associated with the first user, where a first visit agenda item of the set of visit agenda items for the first visit agenda comprises a set of metrics selected for the first visit agenda item based on the first outlet and the perspective definition associated with the first user;
receiving a user selection of one or more metrics of the set of metrics in association with a user interaction of the first user with the first visit agenda item of the first visit agenda;
storing the first visit agenda comprising the set of visit agenda items, including the first visit agenda item comprising the one or more metrics of the set of metrics; and
dynamically updating the first visit agenda, including dynamically updating the first agenda item in the first visit agenda by updating the one or more metrics of the set of metrics of the first agenda item as the one or more metrics is updated in the data store.

14. The non-transitory computer readable medium of claim 13, wherein the instructions are further for:
determining a second user associated with the outlet and having a second visit agenda associated with the second user stored in the data store, and presenting the second user to the first user in the visit agenda interface, such that the first user can access the second visit agenda associated with the second user.

15. The non-transitory computer readable medium of claim 13, wherein the instructions are further for:
storing the first visit agenda as a first contact report associated with a second time, wherein the first contact report comprises a value of the first visit agenda item, including the one or more metrics, at the first time.

16. The non-transitory computer readable medium of claim 13, wherein dynamically updating the first visit agenda comprises:
determining that the first user is accessing the first visit agenda at a third time;
determining that the one or more metrics has been updated since the first visit agenda was stored; and
dynamically updating the first visit agenda before presenting the first visit agenda to the first user at the third time based on the determination that the one or more metrics has been updated.

17. The non-transitory computer readable medium of claim 16, wherein the instructions are further for:
storing the first visit agenda as a second contact report associated with a fourth time, wherein the first contact report comprises a value of the first visit agenda item, including the one or more metrics, at the second time.

18. The non-transitory computer readable medium of claim 13, wherein the set of visit agenda items comprise one or more of a recommended metrics visit agenda item, a focus metrics agenda item, or a required visit agenda item.
